(19) United States
(12) Patent Application Publication
(10) Pub. No.: US 2010/0169248 A1
(43) Pub. Date: Jul. 1, 2010

(54) CONTENT DIVISION POSITION DETERMINATION DEVICE, CONTENT VIEWING CONTROL DEVICE, AND PROGRAM

(76) Inventor: Kota Iwamoto, Tokyo (JP)

Correspondence Address: Mr. Jackson Chen, 6535 N. STATE HWY 161, IRVING, TX, 75039, US

(21) Appl. No.: 12/601,487

(22) PCT Filed: May 23, 2008
(86) PCT No.: PCT/JP2008/059543

§ 371 Date: Nov. 23, 2009

(30) Foreign Application Priority Data
May 23, 2007 (JP) 2007-137058

(51) Int. Cl. G06F 15/18; G06F 7/00

(52) U.S. Cl. 706/12; 707/737; 707/E17.005

(57) ABSTRACT

A content division position determination device 10 comprises a repetitive signal section group detection unit 1 detecting a group of repetitive signal sections in which signals are similar to one another from at least one content as a repetitive signal section group and outputting information identifying each of the repetitive signal sections contained in the repetitive signal section group as repetitive signal section group information, a preceding and following section description feature value extraction unit 2 extracting, from the content, preceding and following section description feature values, which are feature values describing the preceding and following section of each of the repetitive signal sections identified by the repetitive signal section group information, and a preceding and following section description feature value analysis unit 3 calculating a division position reliability indicating a probability that each of the repetitive signal section contained in the repetitive signal section group is a division position by using the preceding and following section description feature values.

### REFERENCE TO RELATED APPLICATION

The present invention is the National Phase of PCT/JP2008/059543, filed May 23, 2008, which is based upon and claims the benefit of the priority of Japanese patent application No. 2007-137058, filed on May 23, 2007, the disclosure of which is incorporated herein in its entirety by reference thereto.

### TECHNICAL FIELD

The present invention relates to a content division position determination device, method, and program for determining temporal division positions of a content and to a content viewing control device, method, and program. In particular, the present invention relates to a content division position determination device, method, and program for determining meaningful division positions of a content and to a content viewing control device, method, and program using a content division position determination device.

### BACKGROUND ART

To efficiently access/view contents including broadcast contents such as television programs, it is effective to meaningly divide a content on a time axis. The “meaningly divide a content” means dividing a content into meaningful units. For example, in the case of a broadcast content, it is effective to divide the content into corners (variety program, educational program, hobby/entertainment program, and documentary program) or topics (news program) as meaningful units.

As techniques relating to the present invention, for example, Patent Documents 1 to 3 disclose a method for determining meaningful division positions of a content.

According to the method disclosed in Patent Document 1, pattern recognition processing is performed on a content to obtain character strings. The character strings are then analyzed to obtain division positions. Meaningful image division positions are determined by evaluating the division positions and signal change points in an integrated fashion. Patent Document 2 discloses a method for determining meaningful image division positions of a content by using a pattern in which text contained the content appears. Further, according to the method disclosed in Patent Document 3, a content is divided into shots, and a feature value extracted from each shot is learned to generate a discriminator. Meaningful image division positions are determined by using the discriminator.

However, based on the methods disclosed in Patent Documents 1 to 3, it is difficult to accurately determine meaningful division positions, such as division positions indicating corners or topics, designed by content producers. This is because the above methods do not use information that explicitly indicates meaningful division positions designed by content producers.

As a method for determining meaningful division positions designed by content producers, it is effective to detect characteristic short acoustic signals or video signals that indicate meaningful division positions (the start of a corner or a topic, for example) of a content and that are inserted during a production phase of the content. Generally, characteristic short acoustic signals or video signals that explicitly indicate meaningful division positions of a content are referred to as “jingles.” While a “jingle” normally signifies only such acoustic signal as described above, the jingle used herein also signifies such video signal as described above. A short jingle plays about 1 second and a long jingle about 10 to 19 seconds.

The characteristic short acoustic signals or video signals that explicitly indicate meaningful division positions of a content are repeatedly used for meaningful division positions having the same meaning (the start of the same corner or topic, for example) in a single content or in a plurality of contents (in a plurality of contents of a single series, for example). For example, Patent Documents 4 to 6 disclose a method for determining meaningful division positions of a content by using this feature. According to the method, the determination is made by detecting repetitive signals that appear repeatedly in a content based on similarity of the signals.

Patent Document 4 discloses a server that provides TV listing data with jingle information before transmitting the TV listing data. This document also discloses a recorder that meaningly divides a content based on the jingle information. According to this document, autocorrelation is executed to extract jingles.

Patent Document 5 discloses a method for determining meaningful image division positions of a content by detecting a scene change image commonly used in a plurality of contents repeatedly.

Patent Document 6 discloses a method for automatically detecting media objects including jingles repeatedly embedded in a content. These methods for determining meaningful division positions of a content by detecting repetitive signals that appear repeatedly in the content as jingles are suitable for determining meaningful division positions designed by content producers.

Patent Document 1: JP Patent Kokai Publication No. JP2004-240848 A

Patent Document 2: JP Patent Kokai Publication No. JP2007-6454 A

Patent Document 3: JP Patent Kokai Publication No. JP2006-135387 A

Patent Document 4: JP Patent Kokai Publication No. JP2004-363749 A

Patent Document 5: JP Patent Kokai Publication No. JP11-259061 A

Patent Document 6: JP Patent Kohyo Publication No. JP2006-515721 A

### SUMMARY

The entire disclosures of the above Patent Documents 1 to 6 are incorporated herein by reference thereto. The related techniques will be hereinafter analyzed based on the present invention.

However, the above techniques for determining meaningful division positions of a content involve the following problems. According to the methods disclosed in Patent Documents 1 to 3, as described above, it is difficult to accurately determine meaningful division positions designed by content producers. This is because these methods do not use information that explicitly indicates meaningful division positions designed by content producers.

The methods disclosed in Patent Documents 4 to 6 determine meaningful division positions of a content by detecting repetitive signals that appear repeatedly in a content based on similarity of the signals. While these methods are suitable for determining meaningful division positions designed by content producers, the methods involve the following problems.

Namely, according to the methods disclosed in Patent Documents 4 to 6, repetitive signals that do not indicate meaningful division positions are also excessively detected. Thus, the repetitive signals that indicate meaningful division positions cannot be distinguished from the repetitive signals that do not indicate meaningful division positions. Examples of the excessively detected repetitive signals that do not indicate meaningful division positions include acoustic signals such as laughter, applause, speech (particularly frequently used words, for example), sound effects, and commercials and video signals such as scenes filmed at the same studio, conversation scenes, scenes filmed at the same location for a long period of time (sports video, for example), and commercials. Namely, according to these methods, it is difficult to accurately determine meaningful division positions.

This is because, according to these methods, repetitive signals detected based on signal similarity alone are determined as meaningful division positions. Namely, such repetitive signals detected based on signal similarity include not only the repetitive signals (jingles) that indicate meaningful division positions, but also the repetitive signals (laughter, applause, speech, sound effects, commercials, scenes filmed at the same studio, conversation scenes, scenes filmed at the same location for a long period of time, and the like) that do not indicate meaningful division positions. Further, the above related techniques provide no methods for distinguishing these signals.

The present invention has been made in view of the above problems. An object of the present invention is to accurately detect meaningful division positions designed by content producers, without excessively detecting positions (laughter, applause, speech, sound effects, commercials, scenes filmed at the same studio, conversation scenes, scenes filmed at the same location for a long period of time, and the like) that do not indicate meaningful division positions.

More specifically, an object of the present invention is to provide a method for detecting repetitive signals in a content and determining meaningful division positions. Based on the method, a probability of meaningful division positions is determined to distinguish between the repetitive signals that indicate meaningful division positions and the repetitive signals that do not indicate meaningful division positions. In this way, meaningful division positions can be determined and detected accurately.

According a first aspect of the present invention, there is provided a content division position determination device for determining temporal division positions of a content. The device comprises a repetitive signal section group detection unit detecting, when supplied with at least one content, a group of repetitive signal sections in which signals are similar to one another as a repetitive signal section group from the content and outputting information for identifying each of the repetitive signal sections contained in the repetitive signal section group as repetitive signal section group information; a preceding and following section description feature value extraction unit extracting, from the content, preceding and following section description feature values, which are feature values describing the preceding and following sections of each of the repetitive signal sections identified by the repetitive signal section group information; and a preceding and following section description feature value analysis unit calculating a division position reliability that indicates a probability that each of the repetitive signal sections contained in the repetitive signal section group indicates a division position by using the preceding and following section description feature values corresponding to a plurality of repetitive signal sections contained in the repetitive signal section group.

According to a second aspect of the present invention, there is provided a content viewing control device for controlling viewing of the content based on the division position information or the repetitive signal section group and the division position reliability outputted by the above content division position determination device.

According to third and fourth aspects of the present invention, there are provided; a division position determination method corresponding to the above content division position determination device; and a computer program that causes a computer to execute processing for determining temporal division positions of the above content to realize the above content division position determination device.

According to the present invention, there is provided: a content division position determination device, method, and program that can accurately detect meaningful division positions designed by content producers, without excessively detecting positions (laughter, applause, speech, sound effects, commercials, scenes filmed at the same studio, conversation scenes, scenes filmed at the same location for a long period of time, and the like) that do not indicate meaningful division positions; and a content viewing control device, method, and program.

### BRIEF DESCRIPTION OF THE DRAWINGS

FIG. 1 illustrates a content division position determination device according to a first exemplary embodiment of the present invention.

FIG. 2 schematically illustrates contents and repetitive signal sections.

FIG. 3 illustrates a specific example of a repetitive signal section group detection unit 1 of the content division position determination device according to the first exemplary embodiment of the present invention.

FIG. 4 is a flow chart illustrating a content division position determination method according to the first exemplary embodiment of the present invention.

FIG. 5 illustrates a first configuration example (a preceding and following section description feature value analysis unit 3A) of a preceding and following section description feature value analysis unit 3 of the content division position determination device according to the first exemplary embodiment of the present invention.

FIG. 6 is a flow chart illustrating an operation of the preceding and following section description feature value analysis unit 3A of the content division position determination device.

FIG. 7 illustrates a second configuration example (a preceding and following section description feature value analysis unit 3B) of the preceding and following section description feature value analysis unit 3 of the content division position determination device.

FIG. 8 is a flow chart illustrating an operation of the preceding and following section description feature value analysis unit 3B of the content division position determination device.

FIG. 9 illustrates a third configuration example (a preceding and following section description feature value analysis unit 3C) of the preceding and following section description feature value analysis unit 3 of the content division position determination device.

FIG. 10 is a flow chart illustrating an operation of the preceding and following section description feature value analysis unit 3C of the content division position determination device.

FIG. 11 illustrates a fourth configuration example (a preceding and following section description feature value analysis unit 3D) of the preceding and following section description feature value analysis unit 3 of the content division position determination device.

FIG. 12 is a flow chart illustrating an operation of the preceding and following section description feature value analysis unit 3D of the content division position determination device.

FIG. 13 is a block diagram illustrating a content division position determination device according to a second exemplary embodiment of the present invention.

FIG. 14 is a flow chart illustrating a content division position determination method according to the second exemplary embodiment of the present invention.

FIG. 15 illustrates a content division position determination device according to a third exemplary embodiment of the present invention.

FIG. 16 illustrates a content division position determination device according to a fourth exemplary embodiment of the present invention.

FIG. 17 illustrates a hardware configuration example of the content division position determination device according to the first to fourth exemplary embodiments of the present invention.

### PREFERRED MODES

Specific exemplary embodiments of the present invention will be hereinafter described in detail with reference to the drawings. According to the present embodiments, a group of repetitive signals similar to one another contained in a content is detected, and repetitive signal sections including the individual repetitive signals of the group are detected as candidates for meaningful division positions. Next, characteristics of the feature values describing the preceding and following sections of a plurality of repetitive signal sections of the group are analyzed, a probability that the repetitive signal sections including the individual repetitive signals of the group indicate meaningful division positions, that is, a probability that the preceding and following sections that sandwich the repetitive signal sections including the individual repetitive signals of the group can be divided is calculated. Thus, meaningful division positions (division positions) designed by content producers can be accurately determined.

### First Exemplary Embodiment

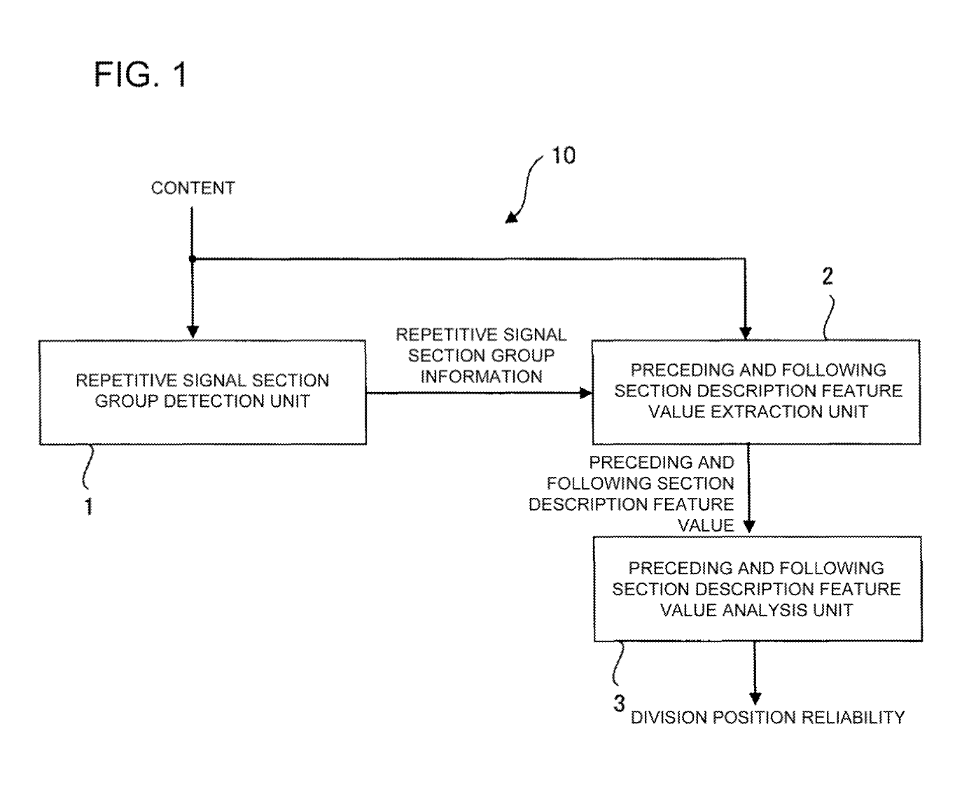

First, a first exemplary embodiment of the present invention will be described in detail with reference to the drawings. FIG. 1 illustrates a content division position determination device according to the present exemplary embodiment. As shown in FIG. 1, a content division position determination device 10 comprises a repetitive signal section group detection unit 1, a preceding and following section description feature value extraction unit 2, and a preceding and following section description feature value analysis unit 3.

When supplied with at least one content, the repetitive signal section group detection unit 1 detects a group of repetitive signal sections in which signals are similar to one another from the content as a repetitive signal section group. The repetitive signal section group detection unit 1 then outputs information for identifying each of the repetitive signal sections included in the repetitive signal section group as repetitive signal section group information.

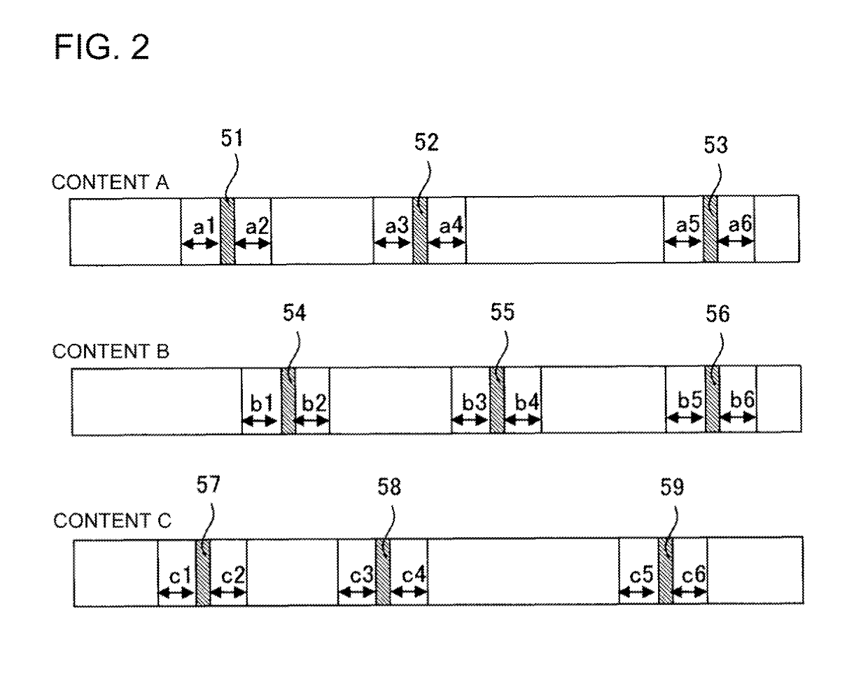

A content is formed by a video signal and/or an acoustic signal, examples of which include a broadcast content such as a television program or a radio program and a content stored in a recording medium such as a DVD. Further, for example, a plurality of contents belonging to the same series, such as a plurality of television programs each aired every week, may be supplied as contents. FIG. 2 schematically illustrates such contents and repetitive signal sections. Contents A, B, and C include repetitive signal sections 51 to 53, 54 to 56, and 57 to 59, respectively. For example, the contents A, B, and C are the shows of the same quiz program aired on the first to third weeks, respectively, and each of the repetitive signal sections 51 to 59 corresponds to the start of a question or the like in the quiz program. As shown in FIG. 2, this quiz program gives three quizzes every week. The above repetitive signal section group is a collection of these repetitive signal sections 51 to 59.

Further, the signal refers to a video signal and/or an acoustic signal included in a content.

The repetitive signal section group information identifies each of the repetitive signal sections included in the repetitive signal section group, examples of which include content identification information and content time information included in each repetitive signal section. The time information represents the time, a frame number, or the like that indicates the start and end points of each repetitive signal section. Namely, based on the example shown in FIG. 2, the repetitive signal section group information is contained in each of the repetitive signal sections 51 to 59 and identifies the repetitive signal sections 51 to 59. The information identifying the repetitive signal sections 51 to 59 represents the time or a frame number that indicates the start and end points of each of the repetitive signal sections 51 to 59.

The repetitive signal section group detection unit 1 may detect the repetitive signal section group from a content based on an arbitrary method. Next, a specific configuration example of the repetitive signal section group detection unit 1 will be described.

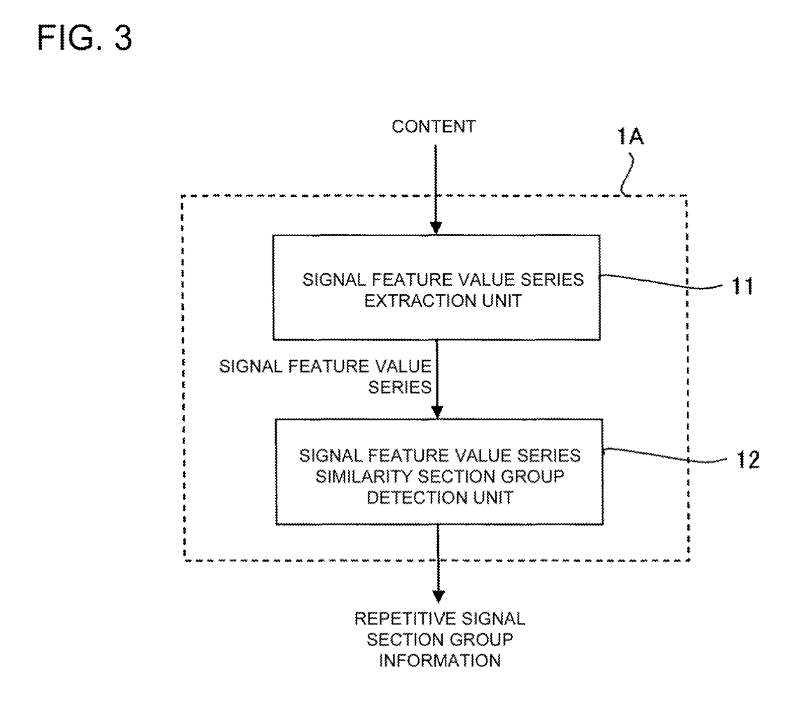

FIG. 3 illustrates a specific example of the repetitive signal section group detection unit 1. As shown in FIG. 3, a first configuration example (hereinafter referred to as a repetitive signal section group detection unit 1A) of the repetitive signal section group detection unit 1 comprises a signal feature value series extraction unit 11 and a signal feature value series similarity section group detection unit 12.

When supplied with at least one content, the signal feature value series extraction unit 11 extracts a signal feature value series, which is a series of signal feature values, from the content. A signal feature value refers to a feature value representing a video signal and/or an acoustic signal contained in a content.

For example, image feature values are extracted from images of the individual frames of a content and used as a series of signal feature values representing video signals. A feature value representing brightness information, color information, edge information, texture information, shape information, or motion information can be used as an image feature value. Further, the dominant color, color layout, scalable color, color structure, edge histogram, homogeneous texture, texture browsing, region shape, contour shape, shape 3D, parametric motion, or motion activity defined by international standards ISO/IEC 15938-3 may be extracted, for example.

Alternatively, instead of extracting an image feature value from each of the frames of a content, an image feature value may be extracted from only frames selected at arbitrary sampling intervals, for example. Alternatively, a process such as a cut detection process may be performed to select certain frames, and image feature values may be extracted only from the selected frames. Alternatively, a content may be divided into sections each having an arbitrary length, and an image feature value of each of a plurality of frames contained in each section may be extracted from the section, so that the image feature values may be consolidated and used. The image feature values may be consolidated by determining an average value, a median value, a most frequent value, or a histogram.

An arbitrary number of sampling sections in which continuous acoustic signals (acoustic waveforms) exist, which will be hereinafter referred to as an acoustic frame, may be analyzed, extracted, and used as a series of signal feature values representing acoustic signals. For example, by performing a frequency transform such as Fourier transform on such acoustic frames and extracting the spectra thereof, an average power of the spectra, an average power for each frequency range, spectrum flatness, spectrum flatness for each frequency range, or the like may be extracted as a signal feature value representing the acoustic signals.

The signal feature values extracted by the signal feature value series extraction unit 11 are not limited to the above feature values. An arbitrary signal feature value may be used as long as the signal feature value represents a video signal and/or an acoustic signal contained in a content.

The signal feature value series similarity section group detection unit 12 detects a group of sections in which signal feature values are similar to one another from a signal feature value series extracted by the signal feature value series extraction unit 11 as a repetitive signal section group. Namely, based on the example shown in FIG. 2, the sections 51 to 59 in which signal features are similar to one another are detected as a repetitive signal section group. The signal feature value series similarity section group detection unit 12 outputs information identifying each of the repetitive signal sections contained in the repetitive signal section group as repetitive signal section group information. Namely, information identifying the repetitive signal sections 51 to 59 is outputted as repetitive signal section group information.

For example, a method disclosed in Non-Patent Document 1 (Eiji Kasutani, Ryoma Oami, Akio Yamada, Takami Sato, Kyoji Hirata, “Video Material Archive System for Efficient Video Editing based on Medai Identification”, Proc. on International Conference on Multimedia and Expo (ICME2004), Vol. 1, pp. 727-730, June 2004) may be used as a method for detecting sections in which signal feature values are similar to one another from a signal feature value series.

Non-Patent Document 1 discloses a method for detecting sections in which signal feature values are similar to one another from a signal feature value series of video signals. According to the method disclosed in Non-Patent Document 1, first, a section having a short time length is extracted as a query section (reference section) from a signal feature value series. From the remaining sections of the signal feature value series, sections each having the same time length as the query section are sequentially extracted along a time axis, and a similarity to the query section is calculated. For the calculation of the similarity, an average value of similarities of image feature values among frames corresponding to the sections is used. For sections having a high similarity to the query section, sections for which the similarity is calculated are extended in negative and positive directions of the time axis. The start and end points of the sections in which signal feature values are similar to one another are determined. When this processing is completed for a certain query section, the next query section is extracted, and the same processing is repeated. By integrating the sections in which signal feature values are similar to one another obtained in this way, a group of sections in which signal feature values are similar to one another can be detected.

The entire disclosure of the above Non-Patent Document 1 is incorporated herein by reference thereto.

In addition to a signal feature value series of video signals, the method disclosed in Non-Patent Document 1 can be similarly applied to a series of signal feature values representing acoustic signals. When detecting sections in which signal feature values are similar to one another, the level of similarity of signal feature values to be detected as similar sections can be arbitrarily determined. Thus, even when text, background sound, or the like is superimposed, similarity can be detected.

Patent Document 6 also discloses a method for detecting sections in which signal feature values are similar to one another from a signal feature value series. According to the method disclosed in Patent Document 6, media objects in a media stream are located, and temporal endpoints for each media object are determined. First, characteristic information for at least one segment of a media stream is computed, and the characteristic information is analyzed to determine whether a media object is possibly present within any segment of the media stream. Next, the location and characteristic information of any segment of the media stream are stored in an object database when the analysis of the characteristic information indicates that at least part of a media object is possibly present within that segment of the media stream. The object database is queried to locate potentially matching segments of the media stream, and potentially matching segments of the media stream are compared to identify repeating segments within the media stream. Subsequently, portions of the media stream centered on each repeating segment of the media stream are automatically aligned and compared to determine temporal endpoints for each media object in the media stream.

Further, a method disclosed in Non-Patent Document 2 (Nishimura Takuichi, Mizuno Michinao, Ogi Shinobu, Sekimoto Nobuhiro, Oka Ryuichi “Same Interval Retrieval from Time-Series Data Based on Active Search. Reference Interval-Free Time-Series Active Search (RIFAS)” The Transactions of the Institute of Electronics, Information and Communication Engineers. D-11, Vol. J84-D-11, No. 8, pp. 1826-1837, August 2001) may be used.

Conventionally, there has been proposed a time-series active search for searching a time-series database of sound or moving images (input) for an interval that matches a query of a fixed interval (reference pattern) at a high speed. Non-Patent Document 2 proposes a reference interval-free time-series active search as a method for detecting similar partial intervals of two time series at a high speed without capturing time intervals in advance. According to this method, basically, a certain interval is captured from a reference pattern, and as in a conventional time-series active search, similarity between the interval and an input partial interval is determined by comparing histograms. When a lower similarity is determined, more frames are skipped, and the search is continued. However, since, in addition to an input axis direction, a reference axis direction is also considered for the direction of this skip, a search can be made at a higher speed, compared with cases in which a conventional time-series active search method is repeated.

The entire disclosure of the above Non-Patent Document 2 is incorporated herein by reference thereto.

The method for detecting sections in which signal feature values are similar to one another is not limited to these methods. An arbitrary method for detecting sections in which signal feature values are similar to one another may be used.

The preceding and following section description feature value extraction unit 2 extracts, from a content, preceding and following section description feature values, which are feature values describing the preceding and following sections of each of the repetitive signal sections identified by the repetitive signal section group information outputted by the repetitive signal section group detection unit 1.

The preceding and following section includes a preceding section, which is a temporally preceding section of each of the repetitive signal sections, and/or a following section, which is a temporally following section of each of the repetitive signal sections. The time length of each of the preceding and following sections, namely, sections from which the preceding and following section description feature values are extracted, is arbitrary. For example, a preceding section may precede a repetitive signal section by a predetermined time, and a following section may follow a repetitive signal section by a predetermined time, to extract preceding and following section description feature values from the preceding and following sections. Based on the example shown in FIG. 2, a section a1 is the preceding section of the repetitive signal section 51, and a section a2 is the following section of the repetitive signal section 51. Similarly, sections a3, a5, b1, b3, b5, c1, c3, and c5 are the preceding sections of the repetitive signal sections 52 to 59, respectively. Sections a4, a6, b2, b4, b6, c2, c4, and c6 are the following sections of the repetitive signal sections 52 to 59, respectively.

As to the preceding and following section description feature values, it is desirable that feature values describing preceding sections and feature values describing following sections be extracted separately. Based on a second configuration example to be described later of the preceding and following section description feature value analysis unit 3, the preceding and following section description feature value extraction unit 2 may extract the preceding section description feature values and/or the following section description feature values. Based on first and third configuration examples to be described later of the preceding and following section description feature value analysis unit 3, the preceding and following section description feature value extraction unit 2 extracts both the preceding section description feature values and the following section description feature values. Namely, based on the example shown in FIG. 2, for example, in the case of the repetitive signal section 51, the feature value(s) of the preceding section a1 and/or the following section a2 is (are) extracted as a preceding and following section description feature value(s).

For example, the preceding and following section description feature values extracted by the preceding and following section description feature value extraction unit 2 describe objects extracted from the preceding or following sections of a content. The objects are contained in a content. Examples of the object that can be extracted from a video signal of a content include a face, a figure, a (certain) thing, text, and a screen structure; however, the object is not limited to these examples. Examples of the object that can be extracted from an acoustic signal of a content include a speech sentence (including a character string, a word string, and a keyword) and music; however, the object is not limited to these examples. Namely, based on the example shown in FIG. 2, for example, in the case of the repetitive signal section 51, feature values describing certain figures or the like contained in the preceding section a1 and the following section a2 are extracted from the preceding section a1 and the following section a2 as the preceding and following section description feature values.

The method for extracting these objects is widely and generally established as a pattern recognition technique such as a face extraction technique, a text extraction technique, and a sound recognition technique. Thus, an arbitrary object extraction method may be used.

Feature values describing objects may be a collection of feature values (feature vectors) each describing an extracted object, for example. For example, in the case of a face, a collection of feature vectors each describing an extracted face (feature values describing brightness information or edge information, for example) can be used as the preceding and following section description feature values. Alternatively, feature values each describing a face may be grouped (clustered), and a collection of clustered values may be used as the preceding and following section description feature values. In the case of a speech sentence, a collection of text recognized from individual speech sentences, a collection of keywords extracted from the text, or a collection of keyword vectors representing the frequency of the keywords may be used as the preceding and following section description feature values. Alternatively, individual speech sentences may be grouped (clustered) based on acoustic characteristics thereof, and a collection of clustered values may be used as the preceding and following section description feature values.

Feature values describing objects may be a feature value obtained by consolidating feature values (feature vectors) describing individual objects extracted. For example, the feature values (feature vectors) describing individual objects extracted from each of the preceding and following sections may be consolidated as an average value, a histogram, a probability density distribution, or the like and used as a preceding and following section description feature value. Alternatively, information concerning the presence of an object extracted or statistical information concerning the number of extracted objects may be used as a preceding and following section description feature value; for example, a histogram indicating the number of objects extracted from a plurality of objects may be used.

Instead of the feature values describing objects, the preceding and following section description feature value extraction unit 2 may extract feature values describing scene situations of preceding and following sections of a content as the preceding and following section feature values. A feature value describing a scene situation is information representing a situation at a scene, which includes a feature value representing an indoor scene, an outdoor scene, a conversation scene, studio shooting, a scenery scene, a music scene, or narration. However, the feature describing a scene situation is not limited to these examples.

Further, a preceding and following section feature value may be a feature value describing a filming environment such as camera work or a lighting condition. A feature value describing a scene situation may be text representing a scene situation. Alternatively, a numerical value (feature vector) representing a degree of each scene situation may be used, for example. An arbitrary pattern recognition technique widely and generally used, such as an outdoor indoor determination technique, a scene classification technique, or a music detection technique, may be used as the method for extracting a feature value describing a scene situation.

The preceding and following section description feature value extraction unit 2 may extract a plurality of kinds of feature values as the preceding and following section description feature values. A plurality of kinds of feature values may be integrated based on a method such as a principal component analysis, and the newly obtained feature value may be used as the preceding and following section feature value. The preceding and following section description feature values extracted by the preceding and following section description feature value extraction unit 2 are not limited to the above feature values; arbitrary feature values may be used as long as the feature values describe preceding and following sections.

The preceding and following section description feature value analysis unit 3 calculates a division position reliability that represents a probability that the repetitive signal section group indicates division positions. The preceding and following section description feature value analysis unit 3 calculates a division position reliability by using the preceding and following section description feature values corresponding to a plurality of repetitive signal sections contained in a repetitive signal section group extracted by the preceding and following section description feature value extraction unit 2. Namely, a plurality of preceding and following section description feature values are used to calculate a division position reliability for the entire group. The division position reliability represents a probability that the repetitive signal section group indicates meaningful division positions as a numerical value. The higher the probability that a repetitive signal section group indicates meaningful division positions (division positions), the greater the value of the division position reliability. The division position reliability may be a binary value that indicates whether a repetitive signal section group indicates division positions. Alternatively, more accurate or consecutive values may be used, so that a larger (smaller) division position reliability value is calculated for a higher (lower) probability that a repetitive signal section group indicates meaningful division positions. As described above, an extracted division position corresponds to a repetitive signal section and represents a certain section. Thus, by dividing a content at the beginning or the end of the section, it is possible to edit the content, for example.

The preceding and following section description feature value analysis unit 3 can calculate a division position reliability by using characteristics of the preceding and following section description feature values of a repetitive signal section group indicating meaningful division positions previously learned, for example. More specifically, the preceding and following section description feature value analysis unit 3 compares preceding and following section description feature values corresponding to a plurality of repetitive signal sections contained in a repetitive signal section group outputted by the preceding and following section description feature value extraction unit 2 with previously learned characteristics. Based on similarity between the values and the characteristics, the preceding and following section description feature value analysis unit 3 calculates a division position reliability. For example, first, preceding and following section feature values corresponding to a plurality of repetitive signal sections contained in a repetitive signal section group are compared with previously learned characteristics. If many preceding and following section feature values corresponding to the repetitive signal sections have a high similarity to the characteristics, a large division position reliability value may be outputted. The characteristics of the preceding and following section description feature values of a repetitive signal section group indicating meaningful division positions are typical patterns of these preceding and following section description feature values. The characteristics can be learned by preparing a plurality of learning data concerning a repetitive signal section group that indicates meaningful division positions. Namely, based on the example shown in FIG. 2, meaningful division positions of a program, to which the contents A, B, and C also belong, are learned in advance. For example, feature values of the preceding and following sections of a certain section corresponding to the start of a question are learned in advance. The learned feature values are compared with the feature values contained in the preceding and following sections of the repetitive signal sections 51 to 59 extracted from the contents A, B, and C. If these are similar to each other, it is possible to estimate that the repetitive signal sections 51 to 59 indicate meaningful division positions. The method described above is an example for realizing the preceding and following section description feature value analysis unit 3. Other specific configuration examples of the preceding and following section description feature value analysis unit 3 will be described later.

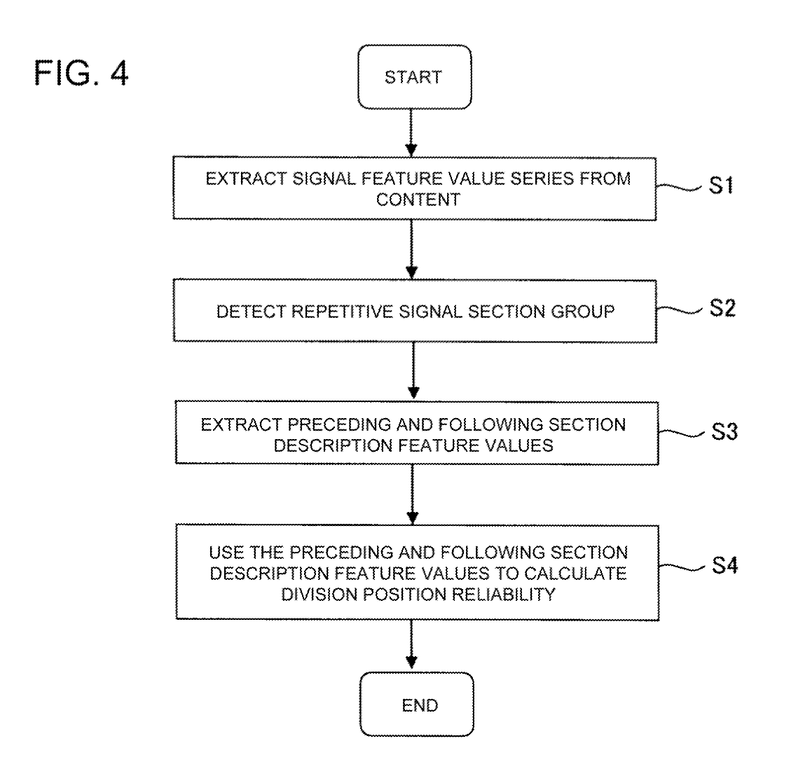

Next, an operation of the repetitive signal section group detection unit 1A according to the first exemplary embodiment shown in FIG. 1 will be described. FIG. 4 is a flow chart illustrating a content division position determination method according to the first exemplary embodiment. As shown in FIG. 4, first, when supplied with at least one content, the signal feature value extraction unit 11 extracts a signal feature value series, which is a series of signal feature values, from the content and supplies the extracted series to the signal feature value series similarity section group detection unit 12 (step S1).

Next, the signal feature value series similarity section group detection unit 12 detects a group of sections in which signal feature values are similar to one another from the signal feature value series as a repetitive signal section group (step S2). Next, the signal feature value series similarity section group detection unit 12 supplies repetitive signal section group information to the preceding and following section description feature value extraction unit 2. Next, the preceding and following section description feature value extraction unit 2 identifies the preceding section and/or the following section of each of the repetitive signal sections identified by the repetitive signal section group information as the preceding and following sections. The extraction unit 2 then extracts preceding and following section description feature values, which are the feature values describing the preceding and following sections, and supplies the feature values to the preceding and following section description feature value analysis unit 3 (step S3). Finally, the preceding and following section description feature value analysis unit 3 uses a plurality of preceding and following section description feature values to calculate and output a division position reliability of the repetitive signal section group (step S4). In the above example, in step S4, the preceding and following section description feature value analysis unit 3 calculates and outputs the division point reliability of the repetitive signal section group based on similarity between the plurality of preceding and following section description feature values and the preceding and following section description feature values of a repetitive signal section group that indicates previously learned meaningful division positions.

Next, effects of the first exemplary embodiment will be described. In a group of repetitive signal sections that indicate meaningful division positions of a content, feature values describing the preceding and following sections of each of the repetitive signal sections have unique characteristics. In order to use such characteristics, the preceding and following section description feature value analysis unit 3 uses preceding and following section description feature values corresponding to a plurality of repetitive signal sections contained in a repetitive signal section group to calculate a division position reliability. Thus, whether the preceding and following section description feature values of an input repetitive signal section group have unique characteristics of the preceding and following section description feature values of a repetitive signal section group that indicates meaningful division positions can be analyzed. In this way, a probability (division position reliability) that a repetitive signal section group indicates meaningful division positions can be calculated reliably. Therefore, repetitive signals indicating meaningful division positions can be detected accurately.

Further, since the preceding and following section description feature value analysis unit 3 uses preceding and following section description feature values corresponding to “a plurality of” repetitive signal sections of a repetitive signal section group to calculate a division position reliability for the entire repetitive signal section group, a division position reliability can be calculated more reliably, compared with cases in which a division position reliability is calculated by analyzing the repetitive signal sections individually.

Thus, by calculating a division position reliability for the entire repetitive signal section group, repetitive signals indicating meaningful division positions can be determined more accurately. Namely, based on the example shown in FIG. 2, even when the preceding and following section feature values obtained from the preceding and following sections a1 and a2 of the repetitive signal section 51 are different from the preceding and following section feature values obtained from other preceding and following sections for some reasons, if other preceding and following section feature values are similar, the repetitive signal section 51 can also be determined as a division position.

Further, the preceding and following section description feature value extraction unit 2 extracts preceding and following section description feature values only from preceding and following sections, which are predetermined sections located before and after each of the repetitive signal sections of a repetitive signal section group, respectively. Thus, since there is no need to extract description feature values from the entire content, preceding and following section description feature values can be extracted at a high speed and at low cost.

Next, specific four configurations of the preceding and following section description feature value analysis unit 3 will be described.

### <First Configuration Example of the Preceding and Following Section Description Feature Value Analysis Unit 3>

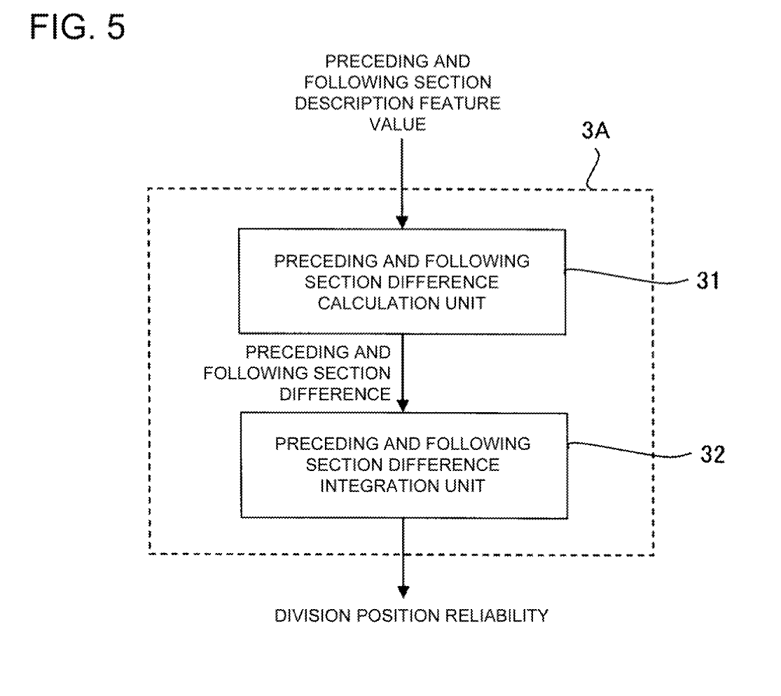

FIG. 5 illustrates a first configuration example of the preceding and following section description feature value analysis unit 3 (hereinafter referred to as a preceding and following section description feature value analysis unit 3A). As shown in FIG. 5, the preceding and following section description feature value analysis unit 3A comprises a preceding and following section difference calculation unit 31 and a preceding and following section difference integration unit 32. The preceding and following section difference calculation unit 31 uses preceding and following section description feature values to calculate a preceding and following section difference, which represents the difference between the preceding section and the following section of each of the repetitive signal sections of a repetitive signal section group.

The larger the difference between a preceding section and a following section, the larger the value of the preceding and following section difference. To calculate the preceding and following section difference of each of the repetitive signal sections by using preceding and following section description feature values, it is necessary to compare a feature value describing the preceding section with a feature value describing the following section. Thus, based on the preceding and following section description feature value analysis unit 3A, the preceding and following section description feature value extraction unit 2 extracts a feature values describing the preceding section and a feature value describing the following section as the preceding and following section description feature values. An arbitrary method for calculating a feature value difference may be used as long as a larger section difference is calculated for a larger difference between the feature values.

A difference between feature values are generally referred to as a distance between feature values, and the calculation method varies depending on the kind of extracted feature values. Thus, it is necessary to choose a distance calculation method depending on the kind of extracted feature values. For example, when the preceding and following section description feature value is a feature value obtained by consolidating feature values describing individual objects extracted or is statistical information and can be represented as a feature vector, the distance between a feature vector describing a preceding section and a feature vector describing a following section may be calculated as a preceding and following section difference. Euclidean distance or Manhattan distance may be used as for the intervector distance, for example. Namely, based on the example shown in FIG. 2, feature values of the preceding section a 1 and the following section a2 of the repetitive signal section 51 are calculated. In this case, the difference between the feature value of the preceding section a1 and the feature value of the following section a2 is determined as a preceding and following section difference. Likewise, the difference between the feature value of the preceding section a3 and the feature value of the following section a4 of the repetitive signal section 52 is determined as a preceding and following section difference. The other repetitive signal sections 53 to 59 are also processed in this way.

Alternatively, a preceding and following section difference may be calculated based on cosine similarity between vectors. In this case, the calculation is made so that a smaller cosine similarity represents a larger value of the preceding and following section difference. Further, if a preceding and following section description feature value is represented as probability density distribution, a preceding and following section difference may be calculated based on the distance of or the overlapping degree of the probability density distribution between a probability density distribution describing the preceding section and a probability density distribution describing the following section. Further, if a preceding and following section description feature value is represented as text, a preceding and following section difference may be calculated based on the matching degree of text (percentage of matching words, for example). In this case, the calculation is made so that a smaller matching degree represents a larger value of the preceding and following section difference.

Further, when preceding and following section description feature values are a collection of feature values (feature vectors) describing individual objects extracted, for example, feature values describing individual objects are extracted from preceding sections and feature values describing individual objects are extracted from following sections, and a distance between the feature values may be calculated for all combinations. The distances may be integrated by an average value calculation process, a weighted addition process, a maximum value calculation process, a median value calculation process, a most frequent value calculation process, a voting process, or the like to calculate a preceding and following section difference. Further, between feature values describing individual objects extracted from preceding sections and feature values describing individual objects extracted from following sections, a preceding and following section difference may be calculated based on a cut value based on a graph cut theory, such as normalized cuts (or normalized association), proposed by Jianbo Shi, Jitendra Malik, “Normalized Cuts and Image Segmentation”, IEEE Transactions on Pattern Analysis and Machine Intelligence, Vol. 22, No. 8, pp. 888-905, August 2000 (Non-Patent Document 3).

The entire disclosure of the above Non-Patent Document 3 is incorporated herein by reference thereto.

A graph cut such as a normalized cut is a type of clustering (grouping) method and is formulated as an optimization problem for dividing a graph composed of nodes connected by edges. Namely, nodes are considered as objects to be clustered, and when a graph is made, similarity between a pair of nodes is treated as an edge. The total of edges to be removed when dividing this graph into two parts is a cut value (by normalizing this value based on the number of nodes, a normalized cut value is obtained), and a division method for minimizing this is searched for. When calculating such cut value by using feature values describing individual objects, individual objects extracted from the preceding and following sections are treated as nodes, and an edge between nodes is treated as a similarity between feature values describing individual objects. In this case, calculation can be made so that a larger distance represents a smaller value of the similarity and a smaller distance represents a larger value of the similarity. Assuming that the preceding section nodes (objects extracted from the preceding sections) and the following section nodes (objects extracted from the following sections) are divided, the total of all edges, each of which connecting a preceding section node and a following section node, that is, the sum of similarities of feature values between objects extracted from the preceding sections and objects extracted from the following sections is considered as the cut value. This value may be normalized based on the number of nodes and used as a normalized cut value. Calculation may be made so that a larger cut value represents a smaller value of the preceding and following section difference and a smaller cut value represents a larger value of the preceding and following section difference.

Further, when a plurality of kinds of preceding and following section description feature values are inputted, a preceding and following section difference may be calculated and outputted for each feature value type. Further, after a preceding and following section difference is calculated for each type of feature value, the differences may be integrated and outputted as a single preceding and following section difference. When a preceding and following section difference is calculated for each feature value type, in order to integrate preceding and following section differences of different feature value types, some normalization process is performed for each type. Thereafter, for example, the preceding and following section differences may be integrated by using a process, such as an average value calculation process, a weighted addition process, a maximum value calculation process, a median value calculation process, or a most frequent value calculation process, to calculate an integrated single preceding and following section difference.

Alternatively, whether a preceding and following section difference is larger than a predetermined threshold value may be determined for each feature value type, and based on the number of feature value types of which preceding and following section difference is larger than the threshold value, a preceding and following section difference may be outputted. For example, the larger the number of the feature value types, the larger the value of the preceding and following section difference. The above threshold value may be different for each feature value type. The method for consolidating a plurality of numerical values into a single numerical value by performing threshold processing on each of a plurality of numerical values and determining the number of numerical values that satisfy a condition will be hereinafter referred to as a “voting process.” The voting process is effective when only some of a plurality of values satisfy a condition.

The preceding and following section difference integration unit 32 uses preceding and following section differences that correspond to a plurality of repetitive signal sections contained in a repetitive signal section group and that are calculated by the preceding and following section difference calculation unit 31 to calculate a division position reliability. Namely, a plurality of preceding and following section differences are used to calculate a division position reliability for the entire group.

Based on the method for calculating an integrated division position reliability with the use of a plurality of preceding and following section differences, for example, first, a plurality of preceding and following section differences are integrated by a process, such as an average value calculation process, a weighted addition process, a maximum value calculation process, a median value calculation process, or a most frequent value calculation process. The calculation can be made so that the larger the value of the integrated preceding and following section difference, the larger the value of the division position reliability. Namely, based on the above example shown in FIG. 2, an average value or the like of the preceding and following section differences of the repetitive signal sections 51 to 59 is calculated as a division position reliability.

The process for integrating preceding and following section differences is not limited to the above examples; an arbitrary method may be used as long as a plurality of numerical values are consolidated into a single numerical value. The integrated preceding and following section difference may be outputted as a division position reliability without modification. Alternatively, some normalization process, nonlinear transformation, or the like may be performed on the integrated preceding and following section difference before outputted as a division position reliability. Alternatively, after an integrated preceding and following section difference is calculated, whether the integrated preceding and following section difference is larger than a predetermined threshold value may be determined, so that a division position reliability may be outputted as a binary value representing whether a repetitive signal section group indicates division positions.

Further, when calculating a division position reliability with the use of a plurality of preceding and following section differences, a value of each of the plurality of preceding and following section differences may be compared with a predetermined threshold value, and the number of preceding and following section differences of which value is larger than the predetermined threshold value may be determined. The calculation may be made so that the larger the number of the preceding and following section differences, the larger the value of the division position reliability (voting process). In this case, the number may be used as a division position reliability without modification. Alternatively, after some normalization process or nonlinear transformation is performed, the value may be outputted as a division position reliability. Further alternatively, the number may be compared with a predetermined threshold value, and as a result, a division position reliability may be outputted as a binary value representing whether a repetitive signal section group indicates division positions.

When a preceding and following section difference is inputted for each of a plurality of feature value types, a division position reliability may be calculated for each feature value type by using the above method, and a plurality of division position reliabilities, each calculated for each feature value type, may be integrated to calculate and output a single integrated division position reliability. In this case, to integrate division position reliabilities of different feature value types, some normalization process may be performed on the division position reliabilities, each calculated for each feature value type. Thereafter, for example, an average value calculation process, a weighted addition process, a maximum value calculation process, a median value calculation process, or a most frequent value calculation process may be used to calculate an integrated single division position reliability. Further, whether each of the division position reliabilities calculated for feature value type may be compared with a predetermined threshold value. A division position reliability may be outputted based on the number of the feature value types of which division position reliability is determined to be larger than the predetermined threshold value. For example, the calculation may be made so that the larger the number of the feature value types, the larger the value of the integrated division position reliability (voting process). The above threshold value may be different for each feature value type. Further, for example, when the number of division position reliabilities larger than a threshold value is at least one or greater, a value representing whether a repetitive signal section group indicates division positions may be outputted as a division position reliability.

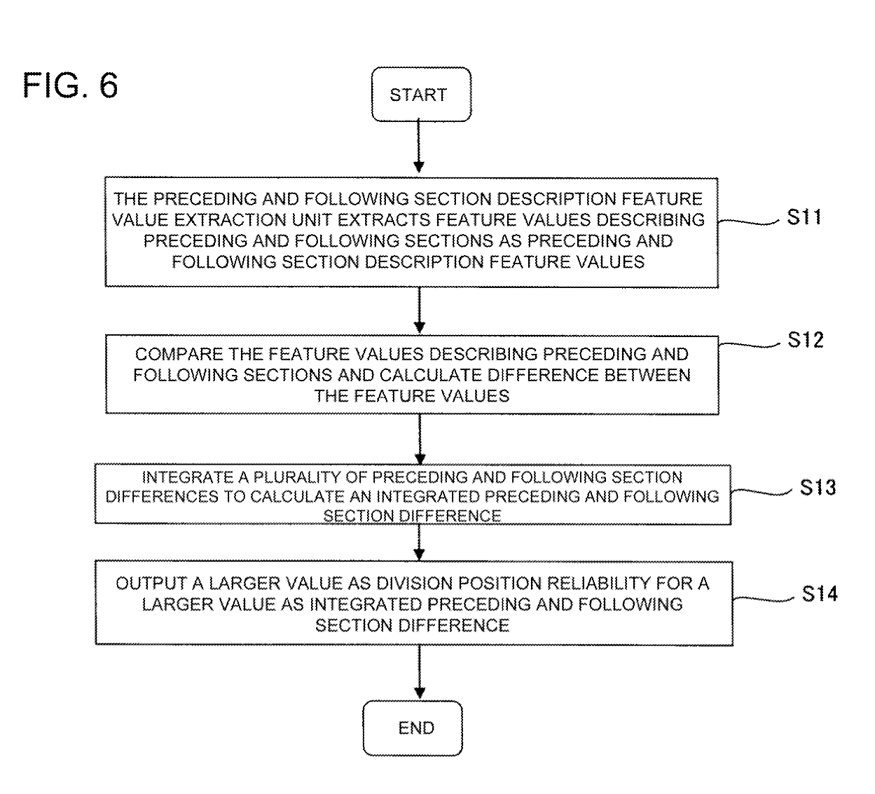

Next, an operation of the preceding and following section description feature value analysis unit 3A will be described. FIG. 6 is a flow chart illustrating an operation of the preceding and following section description feature value analysis unit 3A, showing the details of steps S3 and S4 of the flow chart illustrating the content division determination method according to the first exemplary embodiment shown in FIG. 4.

As shown in FIG. 6, first, the preceding and following section difference calculation unit 31 calculates a preceding and following section difference for each of the repetitive signal sections of a repetitive signal section group, by using preceding and following section description feature values. The following method is used to calculate the difference between a preceding section and a following section. Namely, the preceding and following section description feature value extraction unit 2 extracts a feature value describing a preceding section and a feature value describing a following section for each of the repetitive signal sections as preceding and following section description feature values (step S11). Next, the feature value describing the preceding section and the feature value describing the following section are compared, and the difference between the feature values is calculated (step S12). The calculated difference is supplied to the preceding and following section difference integration unit 32 as a preceding and following section difference.

Next, the preceding and following section difference integration unit 32 uses a plurality of preceding and following section differences to calculate a division position reliability. The following method is used to calculate a division position reliability. Namely, a plurality of preceding and following section differences are integrated to calculate an integrated preceding and following section difference (step S13). A larger value of division position reliability is outputted for a larger integrated preceding and following section difference (step S14).

Next, effects of the preceding and following section description feature value analysis unit 3A will be described. In each of the repetitive signal sections, which are meaningful division positions of a content, a preceding section and a following section have different meanings with each other. Thus, the difference between a feature value describing a preceding section and a feature value describing a following section tends to be large. For example, there may be a large difference in the appearance pattern of objects or in scene situations. Using such characteristics, the preceding and following section description feature value analysis unit 3A calculates a division position reliability, based on the difference between a feature value describing the preceding section and a feature value describing the following section of each of a plurality of repetitive signal sections contained in the repetitive signal section group. In this case, the calculation is made so that the larger the feature value difference, the larger the value of the division position reliability. In this way, it is possible to reliably calculate a probability (division position reliability) that a repetitive signal section group indicates meaningful division positions. Thus, repetitive signals indicating meaningful division positions can be accurately determined.

Further, based on the preceding and following section description feature value analysis unit 3A, the preceding and following section difference integration unit uses preceding and following section differences corresponding to “a plurality of” repetitive signal sections contained in a repetitive signal section group to calculate a division position reliability for the entire repetitive signal section group. In this way, a more reliable division position reliability can be calculated, compared with cases in which a division position reliability is individually calculated for each of the repetitive signal sections. Thus, repetitive signals indicating meaningful division positions can be determined more accurately.

### <Second Configuration Example of the Preceding and Following Section Description Feature Value Analysis Unit 3>

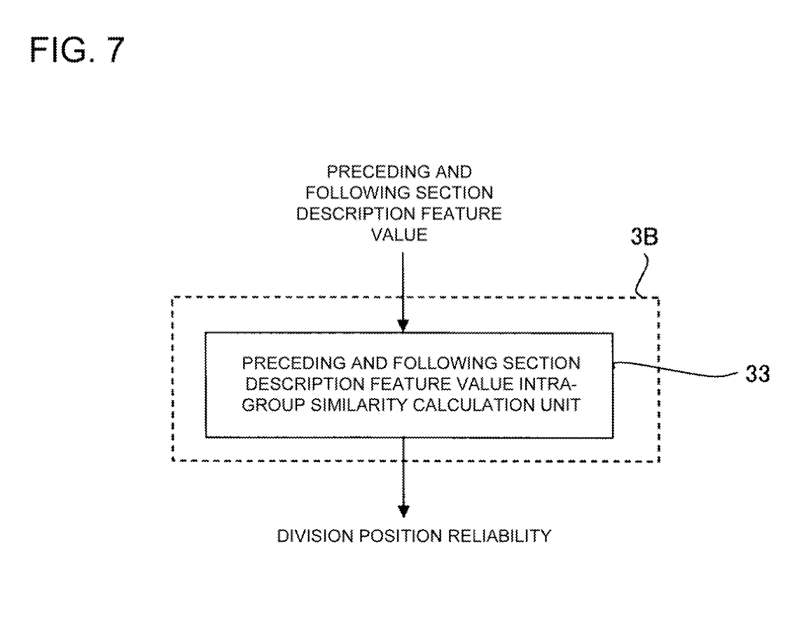

FIG. 7 illustrates a second configuration example (hereinafter referred to as a preceding and following section description feature value analysis unit 3B) of the preceding and following section description feature value analysis unit 3. As shown in FIG. 7, the preceding and following section description feature value analysis unit 3B comprises a preceding and following section description feature value intra-group similarity calculation unit 33. The preceding and following section description feature value intra-group similarity calculation unit 33 calculates a preceding and following section description feature value intra-group similarity, which represents similarity among preceding and following section description feature values extracted from the individual repetitive signal sections contained in a repetitive signal section group. The larger the calculated preceding and following section description feature value intra-group similarity, the larger the value of the division position reliability.

A preceding and following section description feature value intra-group similarity may be calculated only for feature values describing the preceding sections, and based on the similarity, a division position reliability may be calculated. Alternatively, a preceding and following section description feature value intra-group similarity may be calculated only for feature values describing the following sections, and based on the similarity, a division position reliability may be calculated. Further alternatively, a preceding and following section description feature value intra-group similarity may be calculated for each of the preceding and following sections, and based on these similarities, a division position reliability may be calculated. In this case, a division position reliability for the preceding sections and a division position reliability for the following sections may be integrated by a process, such as an average value calculation process, a weighted addition process, a maximum value calculation process, a median value calculation process, a most frequent value calculation process, or a voting process, to calculate an integrated division position reliability.

In order to calculate a preceding and following section description feature value intra-group similarity, which represents similarity among preceding and following section description feature values extracted from the individual repetitive signal sections contained in a repetitive signal section group, similarity among preceding and following section description feature values extracted from a plurality of repetitive signal section in the group is calculated. Namely, based on the example shown in FIG. 2, when using only the feature values describing the preceding sections, feature values are extracted from the preceding sections a1, a3, a5, b1, b3, b5, c1, c3, and c5 of the repetitive signal sections 51 to 59 as the preceding section description feature values, and a similarity among the feature values is used as a preceding and following section description feature value intra-group similarity. When using only the feature values describing the following sections, feature values are extracted from the following sections a2, a4, a6, b2, b4, b6, c2, c4, and c6 of the repetitive signal sections 51 to 59 as the following section description feature values, and a similarity among the feature values is used as a preceding and following section description feature value intra-group similarity. When using both the feature values describing the preceding sections and the feature values describing the following sections, first, the preceding and following section description feature value intra-group similarity of the feature values describing only the preceding sections and the preceding and following section description feature value intra-group similarity of the feature values describing only the following sections are calculated. Next, an average value or the like of the similarities is calculated, and based on the average value, a division position reliability is calculated.

The similarity among feature values has an inverse relation to the difference or the distance between feature values described based on the preceding and following section description feature value analysis unit 3A. Thus, by calculating the difference or the distance between feature values described based on the preceding and following section description feature value analysis unit 3A, the similarity can be calculated. For example, the calculation can be made so that the larger the difference or the distance, the smaller the similarity, and the smaller the difference or the distance, the larger the similarity.

In order to calculate a preceding and following section description feature value intra-group similarity, a similarity among preceding and following section description feature values needs to be calculated. For example, first, a similarity is calculated for all combinations of the preceding and following section description feature values extracted from a plurality of repetitive signal sections in a group. Next, the obtained similarities are integrated by a process, such as an average value calculation process, a weighted addition process, a maximum value calculation process, a median value calculation process, a most frequent value calculation process, or a voting process, to calculate a preceding and following section description feature value intra-group similarity.

As an alternative method for calculating the preceding and following section description feature value intra-group similarity, a dispersion degree of the preceding and following section description feature values extracted from a plurality of repetitive signal sections in a group is calculated. Namely, a preceding and following section description feature value intra-group similarity may be calculated, so that the larger the dispersion degree, the smaller the preceding and following section description feature value intra-group similarity, and the smaller the dispersion degree, the larger the preceding and following section description feature value intra-group similarity. The dispersion degree can be calculated by calculating an average feature value (average feature value vector), determining the distance between the average feature value and each of the preceding and following section description feature values, and calculating an average value of the distances.

When a plurality of types of preceding and following section description feature values are inputted, a preceding and following section description feature value intra-group similarity may be calculated for each feature value type, and the similarities may be integrated to calculate a single preceding and following section description feature value intra-group similarity. In this case, in order to integrate preceding and following section description feature value intra-group similarities of different feature value types, some normalization process may be performed on the preceding and following section description feature value intra-group similarity calculated for each feature value type, and subsequently, a process such as an average value calculation process, a weighted addition process, a maximum value calculation process, a median value calculation process, a most frequent value calculation process, or a voting process, may be used to integrate the similarities.

The preceding and following section description feature value intra-group similarity obtained in this way can be used as a division position reliability without modification. Alternatively, after some normalization process is performed, the similarity can be outputted as a division position reliability. Alternatively, whether the preceding and following section description feature value intra-group similarity is larger than a predetermined threshold value may be determined, and a division position reliability may be outputted as a binary value representing whether a repetitive signal section group indicates division positions.

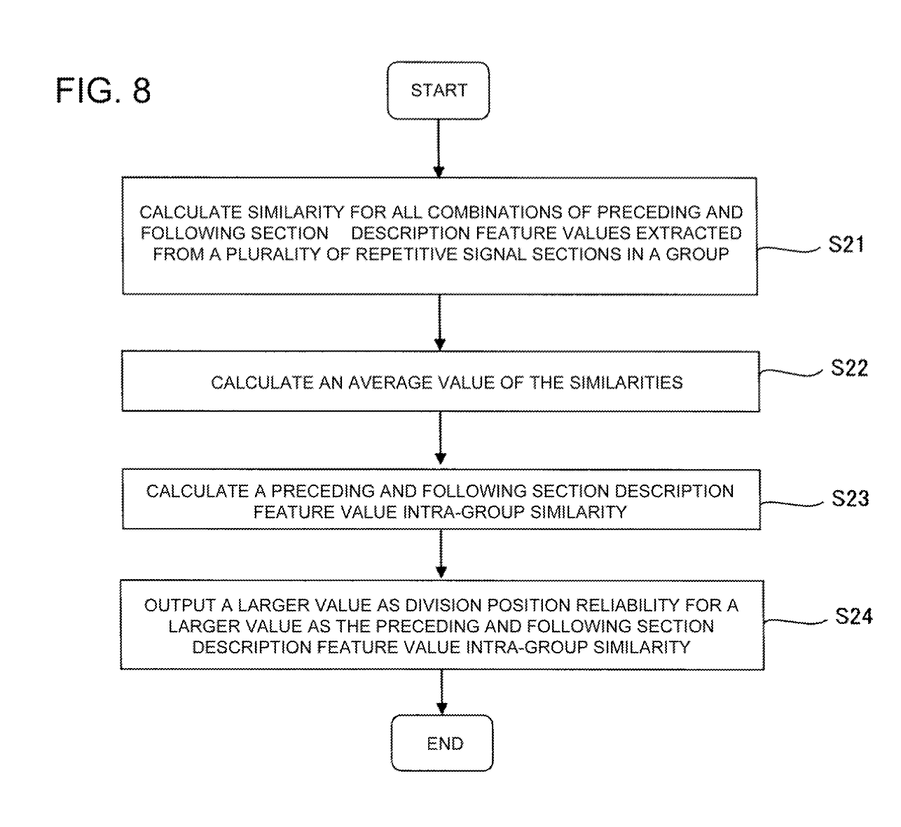

Next, an operation of the preceding and following section description feature value analysis unit 3B will be described. FIG. 8 is a flow chart illustrating an operation of the preceding and following section description feature value analysis unit 3B, showing the details of step S4 in the flow chart illustrating the content division determination method according to the first exemplary embodiment shown in FIG. 4.

First, the preceding and following section description feature value intra-group similarity calculation unit 33 calculates a preceding and following section description feature value intra-group similarity. More specifically, while various methods are available as described above, the following method is used herein. Namely, a similarity is calculated for all combinations of preceding and following section description feature values extracted from a plurality of repetitive signal section in a group (step S21). Next, an average value of these similarities is calculated (step S22). By integrating the similarities in this way, a preceding and following section description feature value intra-group similarity is calculated (step S23). Next, the calculated preceding and following section description feature value intra-group similarity is outputted as a division position reliability. A larger division position reliability is outputted for a larger preceding and following section description feature value intra-group similarity (step S24).

Next, effects of the preceding and following section description feature value analysis unit 3B will be described. Repetitive signal sections indicating meaningful division positions of a content indicate an identical meaning in a repetitive signal section group. Thus, it is characteristic of the preceding and following sections of each of the repetitive signal sections to have a similar feature value. For example, a pattern in which an object appears in the following sections of the repetitive signal sections is similar. In order to use such characteristics, based on the preceding and following section description feature value analysis unit 3B, a division position reliability is calculated based on similarities among preceding and following section description feature values corresponding to the individual repetitive signal sections in a repetitive signal section group. Namely, the calculation is made so that the larger the similarity, the larger the value of the division position reliability. In this way, a probability (division position reliability) that the repetitive signal sections contained in a repetitive signal section group indicate meaningful division positions can be calculated reliably. Thus, repetitive signals indicating meaningful division positions can be determined accurately.

### <Third Configuration Example of the Preceding and Following Section Description Feature Value Analysis Unit 3>

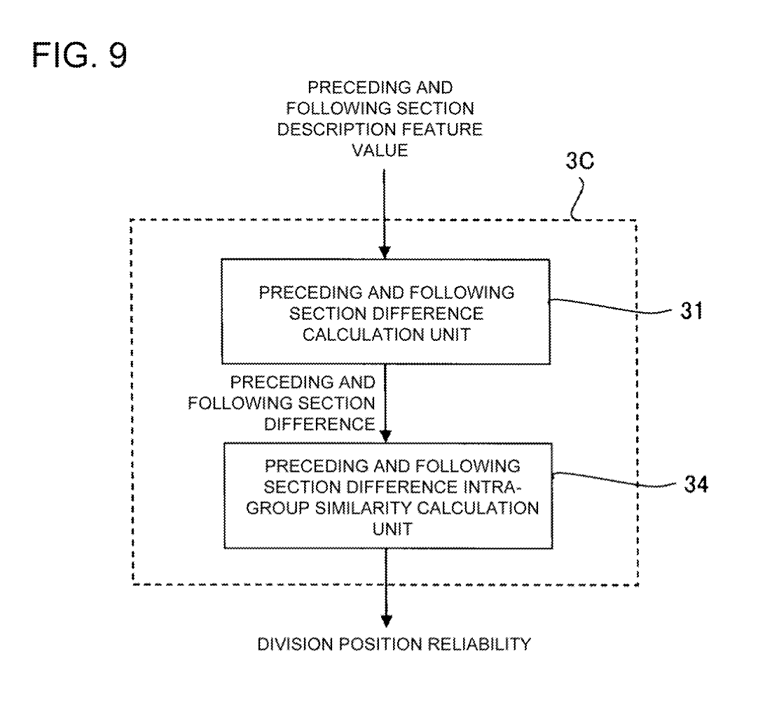

FIG. 9 illustrates a third configuration example (hereinafter referred to as a preceding and following section description feature value analysis unit 3C) of the preceding and following section description feature value analysis unit 3. As shown in FIG. 9, the preceding and following section description feature value analysis unit 3C comprises a preceding and following section difference calculation unit 31 and a preceding and following section difference intra-group similarity calculation unit 34.

Since the preceding and following section difference calculation unit 31 is the same as the preceding and following section difference calculation unit 31 of the preceding and following section description feature value analysis unit 3A shown in FIG. 5, the detailed description thereof will be omitted herein.

First, the preceding and following section difference calculation unit 31 calculates a preceding and following section difference for each of the repetitive signal sections in a repetitive signal section group. Based on the differences, the preceding and following section difference intra-group similarity calculation unit 34 calculates a preceding and following section difference intra-group similarity. The preceding and following section difference intra-group similarity represents a similarity among the preceding and following section differences. The calculation is made so that the larger the value of the calculated preceding and following section difference intra-group similarity, the larger the value of the division position reliability.

To calculate a preceding and following section difference intra-group similarity, it is necessary to calculate a similarity among the preceding and following section differences calculated for a plurality of repetitive signal sections in a group. For example, a value of preceding and following section difference is calculated for all combinations of preceding and following section differences calculated for a plurality of repetitive signal sections in the group. Next, for example, the difference similarities are integrated by an integration process, such as an average value calculation process, a weighted addition process, a maximum value calculation process, a median value calculation process, a most frequent value calculation process, or a voting process, to calculate an integrated difference value. The calculation can be made so that the larger the integrated difference value, the smaller the preceding and following section difference intra-group similarity, and the smaller the integrated difference value, the larger the preceding and following section difference intra-group similarity. Namely, based on the example shown in FIG. 2, the difference between the preceding section a1 and the following section a2 of the repetitive signal section 51 is calculated as a preceding and following section difference. Similarly, the difference between the preceding section a3 and the following section a4 of the repetitive signal section 52 is calculated as a preceding and following section difference. The difference between the preceding and following sections is calculated for each of the other repetitive signal sections 53 to 59. Next, a similarity among the preceding and following section differences of the repetitive signal sections 51 to 59 is calculated as a preceding and following section difference intra-group similarity.

As an alternative method for calculating a preceding and following section difference intra-group similarity, a dispersion value of the preceding and following section differences calculated for a plurality of repetitive signal sections in a group may be calculated. The calculation may be made so that the larger the dispersion value, the smaller the preceding and following section difference intra-group similarity, and the smaller the dispersion value, the larger the preceding and following section difference intra-group similarity.

When preceding and following section differences are inputted for a plurality of feature value types, a preceding and following section difference intra-group similarity may be calculated for each feature value type, and the calculated similarities may be integrated to calculate a single preceding and following section difference intra-group similarity. In this case, after performing some normalization process on the preceding and following section difference intra-group similarity calculated for each feature value type, the preceding and following section difference intra-group similarities of different feature value types may be integrated. To obtain an integrated similarity, for example, an average value calculation process, a weighted addition process, a maximum value calculation process, a median value calculation process, a most frequent value calculation process, or a voting process can be used.

The preceding and following section difference intra-group similarity obtained in this way can be outputted as a division position reliability without modification. Alternatively, some normalization process may be performed on the preceding and following section difference intra-group similarity before outputted as a division position reliability. Further alternatively, whether the preceding and following section difference intra-group similarity is larger than a predetermined threshold value is determined, and based on the results, a division position reliability may be outputted as a binary value representing whether a repetitive signal section group indicates division positions.

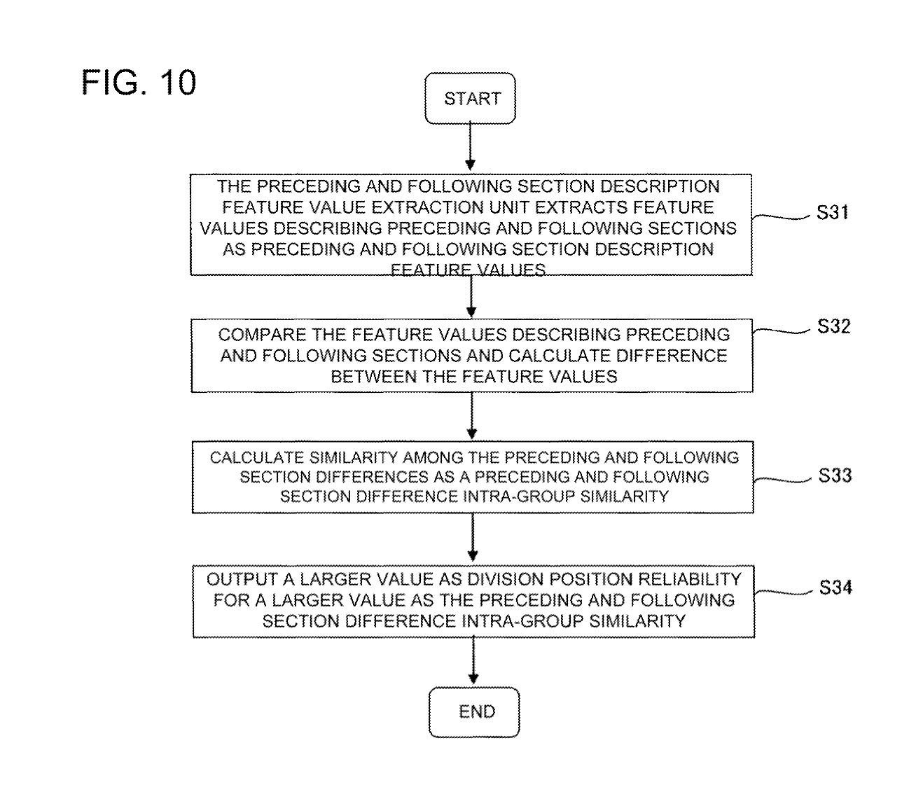

Next, an operation of the preceding and following section description feature value analysis unit 3C will be described. FIG. 10 is a flow chart illustrating an operation of the preceding and following section description feature value analysis unit 3C, showing the details of steps S3 and S4 of the flow chart illustrating the content division determination method according to the first exemplary embodiment shown in FIG. 4.

First, the preceding and following section difference calculation unit 31 calculates a preceding and following section difference for each of the repetitive signal sections of a repetitive signal section group, by using preceding and following section description feature values. More specifically, the preceding and following section description feature value extraction unit 2 extracts a feature value describing a preceding section and a feature value describing a following section for each of the repetitive signal sections as preceding and following section description feature values (step S31). Next, the feature value describing the preceding section and the feature value describing the following section are compared to calculate a difference between the feature values (step S32). The calculated difference is supplied to the preceding and following section difference intra-group similarity calculation unit 34 as a preceding and following section difference.

Next, the preceding and following section difference intra-group similarity calculation unit 34 calculates a similarity among the individual preceding and following section differences in the group as a preceding and following section difference intra-group similarity (step S33). In this case, for example, difference values of the preceding and following section difference are calculated for all combinations of the preceding and following section differences calculated for a plurality of repetitive signal sections in the group, and an average value of the difference values is calculated. The preceding and following section difference intra-group similarity may be calculated, so that the larger the average value of the difference values, the smaller the preceding and following section difference intra-group similarity, and the smaller the average value of the difference values, the larger the preceding and following section difference intra-group similarity. Next, the preceding and following section difference intra-group similarity is outputted as a division position reliability (step S34). In this case, the larger the value of the preceding and following section difference intra-group similarity, the larger the value of the division position reliability.

Next, effects of the preceding and following section description feature value analysis unit 3C will be described. In a repetitive signal section group that indicates meaningful division positions of a content, the repetitive signal sections indicate meaningful division positions having an identical meaning. Thus, it is characteristic of each of the repetitive signal sections to have a similar difference between the preceding section and the following section thereof. To use such characteristics, based on the preceding and following section description feature value analysis unit 3C, a division position reliability is calculated based on a similarity among preceding and following section differences corresponding to each of the repetitive signal sections in a repetitive signal section group. Namely, by calculating a larger value as a division position reliability for a larger similarity, a probability (division position reliability) that a repetitive signal section group indicates meaningful division positions can be calculated reliably. Thus, repetitive signals indicating meaningful division positions can be determined accurately.

### <Fourth Configuration Example of the Preceding and Following Section Description Feature Value Analysis Unit 3>

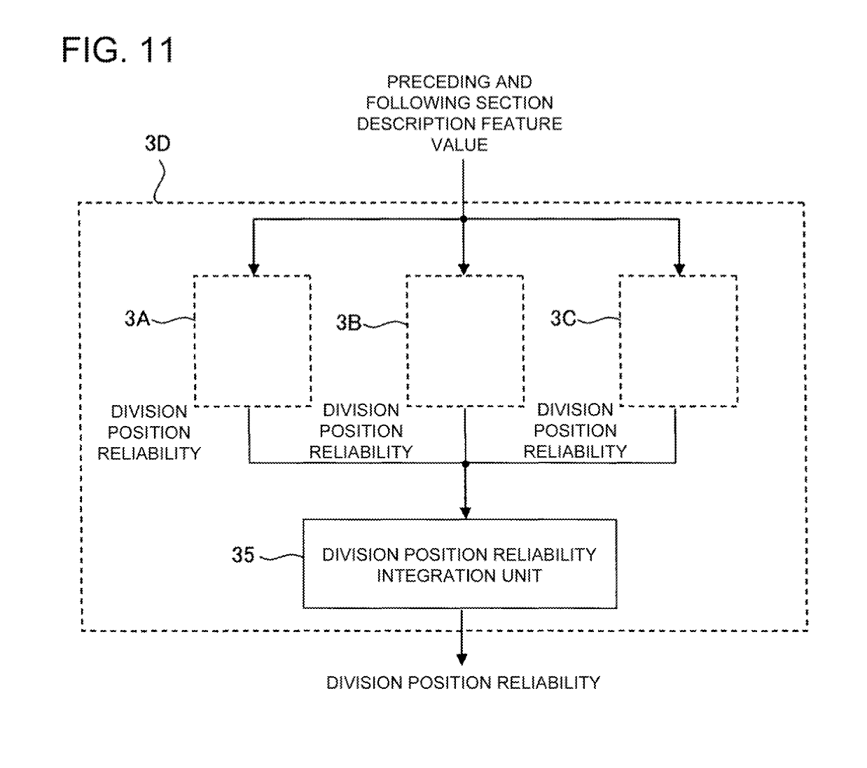

FIG. 11 illustrates a fourth configuration example (hereinafter referred to as a preceding and following section description feature value analysis unit 3D) of the preceding and following section description feature value analysis unit 3. As shown in FIG. 11, the preceding and following section description feature value analysis unit 3D comprises at least two of the preceding and following section description feature value analysis units 3A, 3B, and 3C shown in FIGS. 5, 7, and 9, respectively, in parallel and a division position reliability integration unit 35.

The division position reliability integration unit 35 uses a plurality of division position reliabilities calculated by at least two of the preceding and following section description feature value analysis units 3A to 3C to calculate and output a new division position reliability.

To calculate a new division position reliability by using a plurality of division position reliabilities, for example, an integration process, such as an average value calculation process, a weighted addition process, a maximum value calculation process, a median value calculation process, or a most frequent value calculation process may be used to integrate the plurality of values. Alternatively, a plurality of division position reliabilities may be compared with a predetermined threshold value, and the number of division position reliabilities of which value is larger than the predetermined threshold value may be determined, to calculate a new division position reliability based on the number. In this case, the calculation is made so that the larger the number, the larger the value of the division position reliability. Alternatively, when the number is larger than a predetermined threshold value, a value indicating whether a repetitive signal section group indicates division positions may be outputted as a division position reliability.

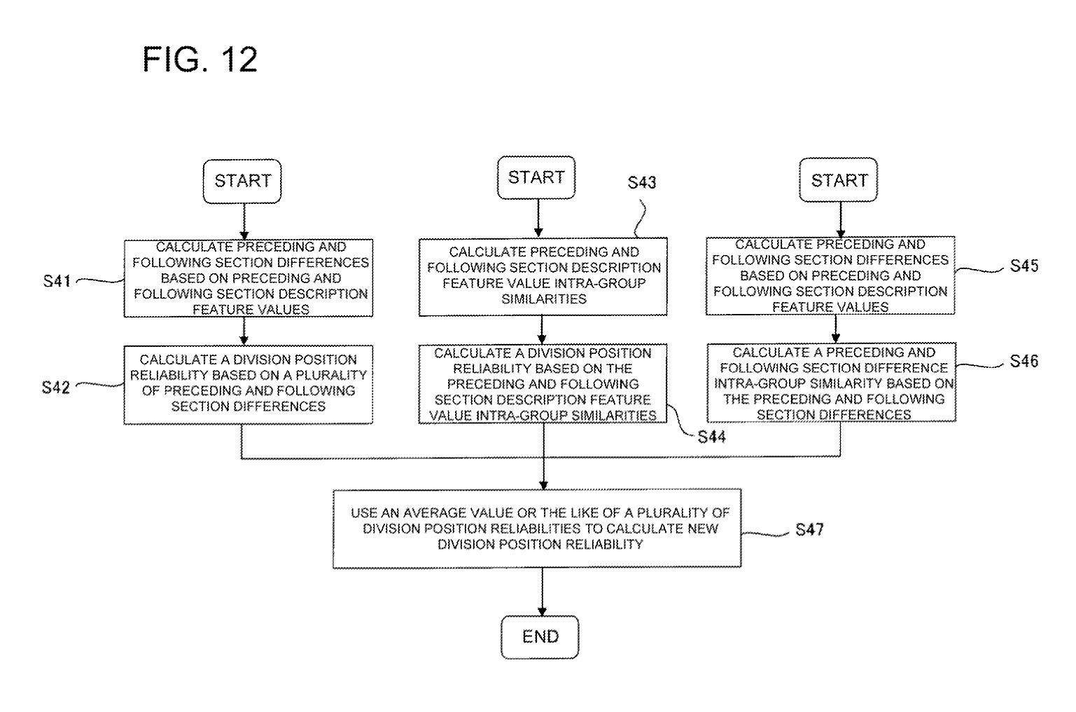

Next, an operation of the preceding and following section description feature value analysis unit 3D will be described. FIG. 12 is a flow chart illustrating an operation of the preceding and following section description feature value analysis unit 3D, showing the details of steps S3 and S4 of the flow chart illustrating the content division determination method according to the first exemplary embodiment shown in FIG. 4.

Description will be hereinafter made, assuming that the preceding and following section description feature value analysis units 3A to 3C are connected in parallel. Each of the preceding and following section description feature value analysis units 3A to 3C operates as described above. Namely, the preceding and following section description feature value analysis unit 3A calculates preceding and following section differences based on preceding and following section description feature values (step S41). Next, the preceding and following section description feature value analysis unit 3A uses a plurality of preceding and following section differences to calculate a division position reliability (step S42). The preceding and following section description feature value analysis unit 3B first calculates preceding and following section description feature value intra-group similarities (step S43). Next, the preceding and following section description feature value analysis unit 3B calculates a division position reliability based on the preceding and following section feature value intra-group similarities (step S44). Further, the preceding and following section description feature value analysis unit 3C uses preceding and following section description feature values to calculate preceding and following section differences (step S45). Next, the preceding and following section description feature value analysis unit 3C calculates a preceding and following section difference intra-group similarity based on the preceding and following section differences and calculates a division position reliability based on the preceding and following section difference intra-group similarity (step S46). In this way, each processing is executed in parallel, and a division position reliability calculated by each of the units is supplied to the division position reliability integration unit 35. Next, the division position reliability integration unit 35 uses a plurality of division position reliabilities to calculate a new division position reliability by determining an average value or the like of the division position reliabilities. The division position reliability integration unit 35 then outputs the new division position reliability (step S47).

Next, effects of the preceding and following section description feature value analysis unit 3D will be described. Based on the preceding and following section description feature value analysis unit 3D, division position reliabilities calculated by a plurality of units can be integrated and a new division position reliability can be outputted. Thus, a division position reliability can be calculated more reliably, compared with cases in which a division position reliability is calculated by a single unit. Thus, repetitive signals indicating meaningful division positions can be determined more accurately. While the preceding and following section description feature value analysis units 3A to 3C are connected in parallel in the above example, the present exemplary embodiment is also applicable when any two of the units are connected in parallel.

### Second Exemplary Embodiment

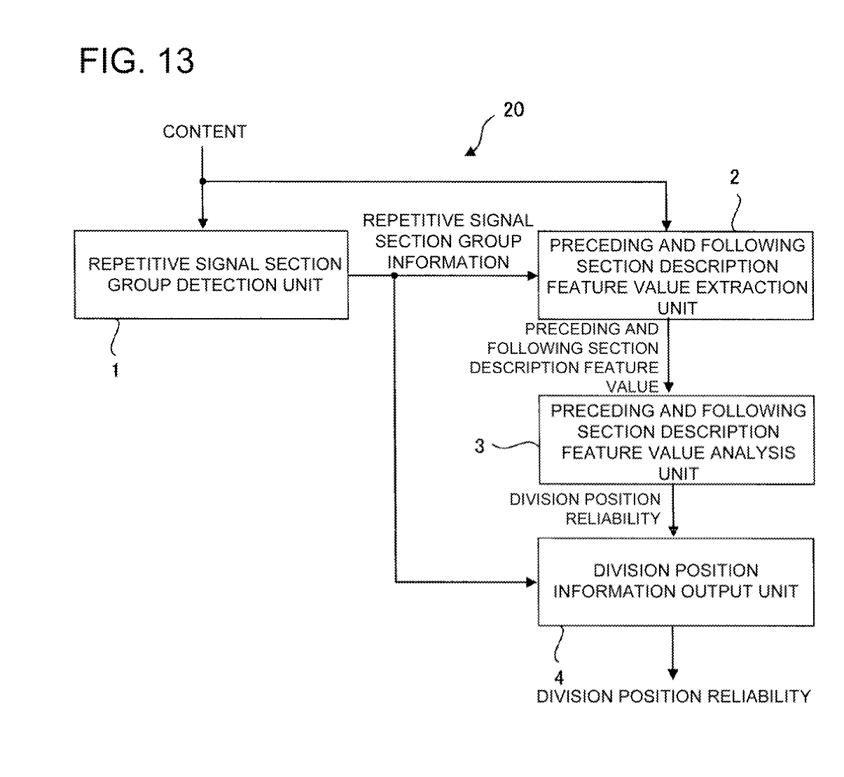

Next, a second exemplary embodiment of the present invention will be described. FIG. 13 is a block diagram illustrating a content division position determination device according to the second exemplary embodiment of the present invention. In addition to the configuration of the first exemplary embodiment shown in FIG. 1, a content division position determination device 20 according to the present exemplary embodiment comprises a division position information output unit 4. In FIG. 13, the components identical to those of the first exemplary embodiment shown in FIG. 1 are designated by the same reference characters, and the detailed descriptions thereof are omitted herein.

The division position information output unit 4 determines whether the repetitive signal section group indicates division positions based on a division position reliability outputted by the preceding and following section description feature value analysis unit 3. If it is determined that the repetitive signal section group indicates division positions, the division position information output unit 4 outputs information identifying division positions as division position information based on the repetitive signal section group information outputted by the repetitive signal section group detection unit 1.

Examples of the division position information include content identification information and content time information contained in each of the repetitive signal sections identified by the repetitive signal section group information. The time information indicates the time or a frame number of the start, middle, or end point of a repetitive signal section. A combination of these items of information may also be used. These items of division position information can be acquired directly from the repetitive signal section group information. Alternatively, the division position information may include an identifier assigned to each repetitive signal section group. By using such identifier assigned to each repetitive signal section group, division positions having an identical meaning can be identified.

If a binary division position reliability is used, whether a repetitive signal section group indicates division positions can be determined directly. If a consecutive value is used as the division position reliability, the division position information output unit 4 may determine the division positions only when the reliability is larger than a predetermined threshold value, for example. In this case, the threshold value does not need to be a fixed value.

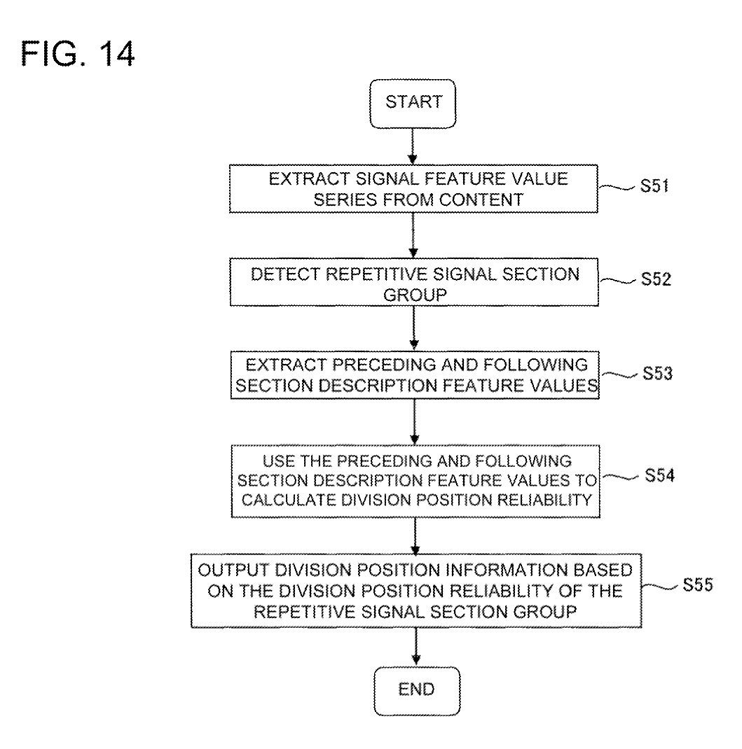

Next, an operation of the second exemplary embodiment will be described. FIG. 14 is a flow chart illustrating a content division position determination method according to the present exemplary embodiment. First, as in the first exemplary embodiment, the operations shown in FIG. 4 are executed. Next, a division position reliability outputted by the preceding and following section description feature value analysis unit 3 and repetitive signal section group information outputted by the repetitive signal section group detection unit 1 are supplied to the division position information output unit 4.

Namely, when supplied with at least one content, the signal feature value series extraction unit 11 extracts a signal feature value series from the content and supplies the series to the signal feature value series similarity section group detection unit 12 (step S51). Next, the signal feature value series similarity section group detection unit 12 detects a repetitive signal section group from the signal feature value series and supplies repetitive signal section group information to the preceding and following section description feature value extraction unit 2 (step S52). Next, the preceding and following section description feature value extraction unit 2 extracts preceding and following section description feature values from each of repetitive signal sections identified by the repetitive signal section group information and supplies the extracted values to the preceding and following section description feature value analysis unit 3 (step S53). The preceding and following section description feature value analysis unit 3 uses a plurality of preceding and following section description feature values to calculate and output a division position reliability of the repetitive signal section group (step S54). Finally, the division position information output unit 4 executes threshold processing or the like on the division position reliability of the repetitive signal section group to determine division position information. If it is determined that the repetitive signal section group indicates division positions, division position information identifying division positions is outputted (step S55).

According to the second exemplary embodiment, since division position information can be outputted based on a division position reliability that reliably represents a probability that repetitive signals indicate meaningful division positions, meaningful division positions can be determined and outputted accurately.

### Third Exemplary Embodiment

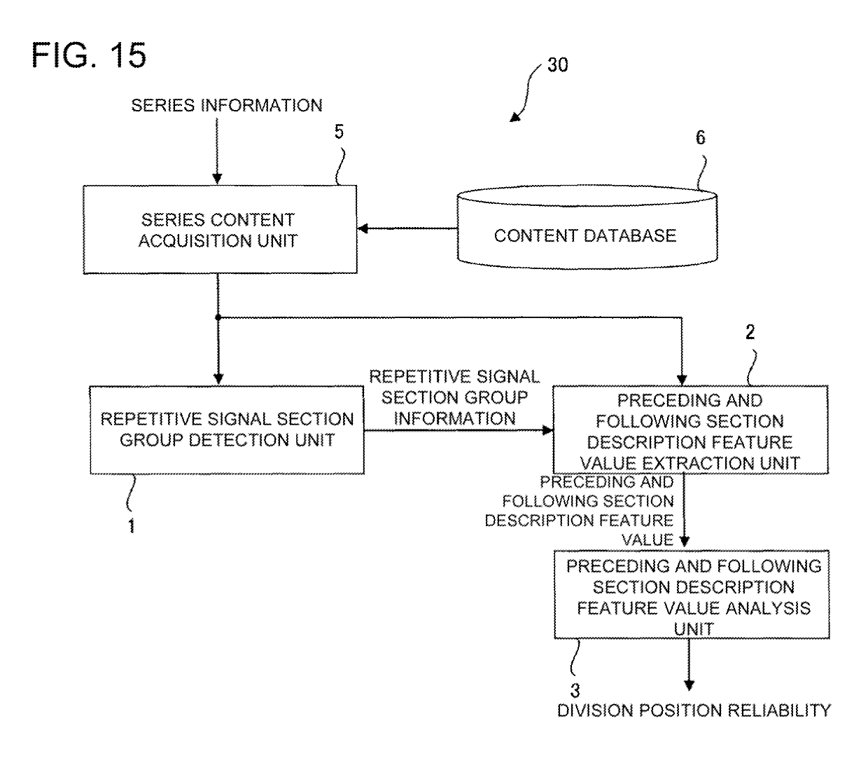

Next, a third exemplary embodiment of the present invention will be described. FIG. 15 illustrates a content division position determination device according to the present exemplary embodiment. As shown in FIG. 15, in addition to the configuration of the first exemplary embodiment shown in FIG. 1, a content division position determination device 30 according to the third exemplary embodiment comprises a series content acquisition unit 5 and a content database 6. While the configuration of the present exemplary embodiment is combined with that of the first exemplary embodiment, it is needless to say that the series content acquisition unit 5 and the content database 6 may be added to the second exemplary embodiment shown in FIG. 13.

The content database 6 is a database storing a plurality of contents. The content database 6 may be a content archive storing a large quantity of contents or a recording device such as a hard disk recorder storing broadcast contents at a content production site such as a broadcast station.

When supplied with series information identifying content series, the series content acquisition unit 5 acquires at least one content corresponding to the series identified by the series information from the content database 6 and supplies the acquired content to the repetitive signal section group detection unit 1.

The “series” refers to a group of contents that have the same content name and that are broadcasted on a weekly, daily, or regular basis in the same broadcast frame (broadcast channel, broadcast day, and broadcast time), for example. A series may be a group of contents sharing an identical element, such as a group of news programs on the same broadcast channel or a group of contents made by the same producer. The series information indicates such identical element, examples of which include information concerning content names or broadcast frames.

The series content acquisition unit 5 can refer to EPG (Electronic Program Guide) information associated with contents stored in the content database 6 and acquire contents corresponding to the relevant series.

Next, an operation of the third exemplary embodiment will be described. First, when supplied with series information, the series content acquisition unit 5 acquires at least one content corresponding to the series from the content database 6 and supplies the acquired content to the repetitive signal section group detection unit 1. Thereafter, a division position reliability is obtained as described in the first exemplary embodiment shown in FIG. 4.

As in the other present exemplary embodiments, the preceding and following section description feature value analysis unit calculates a division position reliability by using preceding and following section description feature values corresponding to a plurality of repetitive signal sections contained in a repetitive signal section group. Thus, whether the preceding and following section description feature values of an input repetitive signal section group have unique characteristics of preceding and following section description feature values of a repetitive signal section group indicating meaningful division positions can be analyzed, whereby a division position reliability can be calculated reliably. Thus, repetitive signals indicating meaningful division positions can be detected accurately.

Further, since contents belonging to the same series are supplied as input contents, a division position reliability can be calculated more reliably, compared with cases in which a series is not identified and all contents are supplied as input contents. This is because since repetitive signals indicating meaningful division positions are inserted by content producers by design, repetitive signals similar to one another are naturally present only in contents belonging to the same series. Thus, by limiting the range of detection of a repetitive signal section group within these contents belonging to an identical series, a probability that repetitive signals that do not indicate meaningful division positions are excessively detected can be reduced, compared with cases in which the range of detection of a repetitive signal section group covers all contents.

### Fourth Exemplary Embodiment

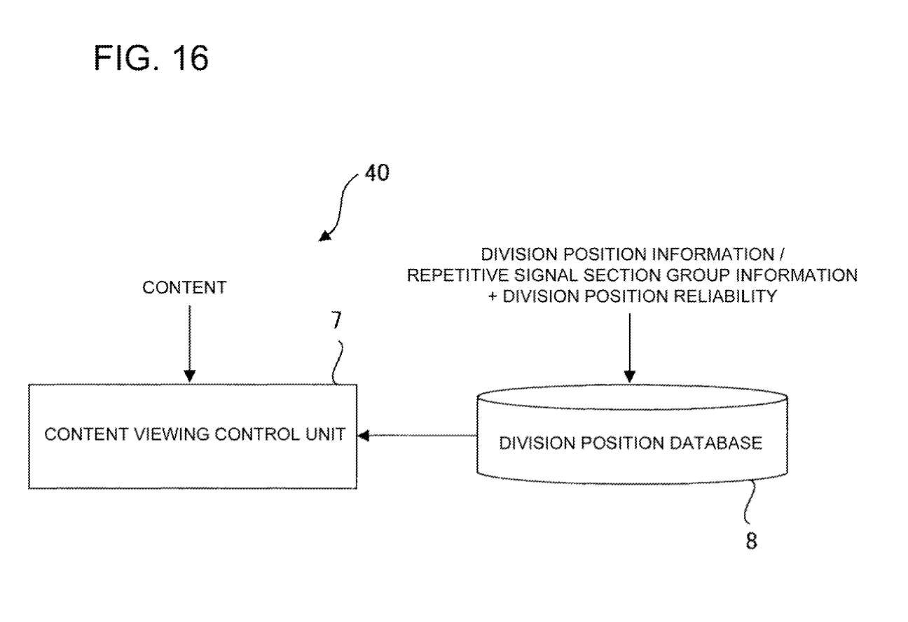

Next, a fourth exemplary embodiment of the present invention will be described. FIG. 16 illustrates a content viewing control device according to the present exemplary embodiment. As shown in FIG. 16, a content viewing control device 40 according to the fourth exemplary embodiment of the present invention comprises a content viewing control unit 7 and a division position database 8.

The division position database 8 is a database that stores division position information or repetitive signal section group information and the division position reliability corresponding thereto for a plurality of contents. The division position database 8 receives and stores the repetitive signal section group information outputted by the repetitive signal section group detection unit 1 and the division position reliability outputted by the preceding and following section description feature value analysis unit 3 according to any one of the first to third exemplary embodiments or the division position information outputted by the division position information output unit 4 according to the second exemplary embodiment.

When supplied with a content, the content viewing control unit 7 acquires the division position information or the repetitive signal section group information and the division position reliability corresponding to the content from the division position database 8. Viewing of the content is controlled based on the acquired division position information or the acquired repetitive signal section group and division position reliability.

According to the content viewing control method based on the division position information or the repetitive signal section group and division position reliability, a viewer can be provided with a list of content division positions identified based on the information or the group and the reliability thereof, and when the viewer specifies a division position, the content can be reproduced at the specified division position (program search). While a division position indicates a repetitive signal section, that is, a certain section, for example, the start or end point of the repetitive signal section can be used as a division point. In addition, during content reproduction, when a viewer specifies a “next division position” or a “previous division position,” the content can be reproduced at the specified division position. The content viewing control method is not limited to the above control methods. The content viewing control method includes all methods as long as viewing of a content is controlled based on division position information or a repetitive signal section group and the division position reliability thereof.

Further, when a repetitive signal section group and the division position reliability thereof are acquired, a threshold value to determine division positions based on the division position reliability may be changed as needed. For example, this threshold value may be arbitrarily controlled by a viewer. In this way, division positions can be provided based on an accuracy desired by the viewer.

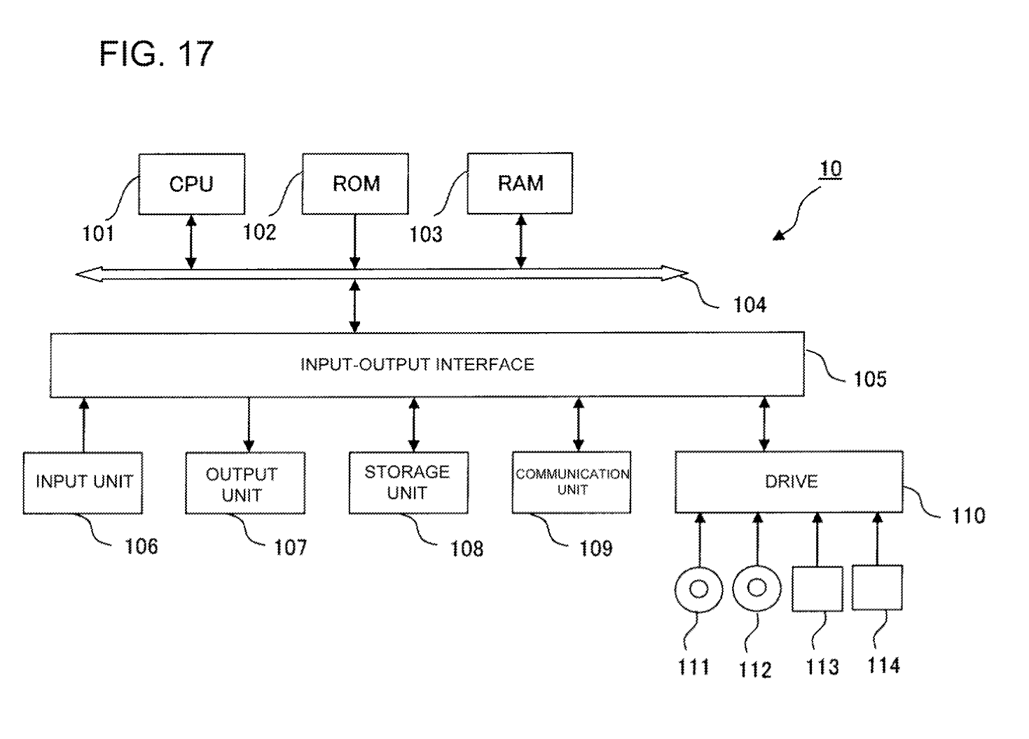

Next, a hardware configuration of the content division position determination devices according to the above-described first to third exemplary embodiments and the content viewing control device according to the fourth exemplary embodiment will be described. The content division position determination devices 10, 20, and 30 and the content viewing control device 40 may be configured similarly. FIG. 17 illustrates an example of the hardware configuration of the content division position determination device according to each of the above exemplary embodiments. As shown in FIG. 17, the content division position determination device comprises a computer in which a CPU (Central Processing Unit) 101, a ROM (Read Only Memory) 102, and a RAM (Random Access Memory) 103 are mutually connected via a bus 104. The OS (operating system) software for operating the computer will not be described herein. However, needless to say, it is assumed that the OS software comprises the content division position determination device.

The bus 104 is also connected to an I/O interface 105. The I/O interface 105 is connected to an input unit 106 including a keyboard or a mouse, a display including a CRT or an LCD, an output unit 107 including a headphone or a speaker, a storage unit 108 including a hard disk, and a communication unit 109 including a modem or a terminal adapter, for example. An input image can be inputted to the input unit 106 and an image orientation can be displayed by the output unit 107.

The CPU 101 executes various types of processing based on various programs which form software modules stored in the ROM 102 or loaded from the storage unit 108 into the RAM 103. For example, the CPU 101 executes various types of processing, such as various types of processing for determining division positions of a content according to the above exemplary embodiments, examples of which include processing for detecting a repetitive signal section group, extracting preceding and following section description feature values, analyzing preceding and following section description feature values, and outputting division position information. The RAM 103 is also supplied with data necessary for various types of processing executed by the CPU 101, as needed.

The communication unit 109 executes communication processing via the Internet (not shown), transmits data supplied from the CPU 101, and outputs data received from the other end of the communication to the CPU 101, the RAM 103, or the storage unit 108. The storage unit 108 communicates with the CPU 101 to store/erase information. The communication unit 109 transmits and receives analog or digital signals to and from other devices.

The I/O interface 105 is also connected to a drive 110 as needed, to which a magnetic disk 111, an optical disk 112, a flexible disk 113, a semiconductor memory 114, or the like is attached as needed. Computer programs read from these devices are installed in the storage unit 108 as needed.

According to the above exemplary embodiments, meaningful division positions designed by content producers can be accurately determined. Thus, according to the present invention, with a content recorder such as a content archive system or a hard disk recorder at a broadcast station, a content can be automatically structured and presented to viewers, and viewing of the content can be controlled.

The present invention is not limited to the exemplary embodiments described above. Needless to say, various modifications can be made without departing from the scope of the present invention. For example, any processing in each of the blocks according to the above exemplary embodiments can be executed by allowing the CPU to execute a computer program. In this case, the computer program recorded in a recording medium may be provided. Alternatively, the computer program transmitted via the Internet or other transmission media may be provided.

Modifications and adjustments of the exemplary embodiments and examples are possible within the scope of the overall disclosure (including the claims) of the present invention and based on the basic technical concept of the present invention. Various combinations and selections of various disclosed elements are possible within the scope of the claims of the present invention.

In the following, preferred modes are summarized.

### Mode 1:

Refer to the content division position determination device of the first aspect.

### Mode 2:

The content division position determination device according to mode 1, wherein the preceding and following section description feature value extraction unit extracts an object from a preceding or following section of the content and extracts a feature value describing the extracted object as a preceding and following section description feature value.

### Mode 3:

The content division position determination device according to mode 2, wherein the object comprises at least one selected from a face, a figure, a thing, text, a screen structure, a speech sentence, and music.

### Mode 4:

The content division position determination device according to any one of modes 1 to 3, wherein the preceding and following section description feature value extraction unit extracts a feature value describing a scene situation of a preceding or following section of the content as a preceding and following section description feature value.

### Mode 5:

The content division position determination device according to any one of modes 1 to 4, wherein the preceding and following section description feature value analysis unit calculates the division position reliability based on a comparison between the preceding and following section description feature values and preceding and following section description feature values of a repetitive signal section group that indicates previously learned meaningful division positions.

Mode 6:

The content division position determination device according to any one of modes 1 to 4, wherein the preceding and following section description feature value analysis unit comprises:

a preceding and following section difference calculation unit calculating a preceding and following section difference that indicates a difference between the preceding section and the following section of each of the repetitive signal sections of the repetitive signal section group by using the preceding and following section description feature values; and

a preceding and following section difference integration unit calculating the division position reliability by using preceding and following section differences corresponding to a plurality of repetitive signal sections contained in the repetitive signal section group.

### Mode 7:

The content division position determination device according to mode 6,

wherein the preceding and following section difference integration unit calculates a preceding and following section difference by integrating the plurality of preceding and following section differences based on at least one process selected from an average value calculation process, a weighted addition process, a maximum value calculation process, a median value calculation process, and a most frequent value calculation process, and

wherein the preceding and following section difference integration unit calculates a larger value as the division position reliability when a larger value is calculated as the integrated preceding and following section difference.

### Mode 8:

The content division position determination device according to mode 6, wherein the preceding and following section difference integration unit compares a value of each of the plurality of preceding and following section differences with a predetermined threshold value, determines the number of preceding and following section differences of which value is larger than the predetermined threshold value, and calculates a larger value as the division position reliability when the number is larger.

### Mode 9:

The content division position determination device according to any one of modes 1 to 4, wherein the preceding and following section description feature value analysis unit comprises a preceding and following section description feature value intra-group similarity calculation unit calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity.

### Mode 10:

The content division position determination device according to any one of modes 1 to 4, wherein the preceding and following section description feature value analysis unit comprises:

a preceding and following section difference calculation unit calculating a preceding and following section difference that indicates a difference between the preceding section and the following section of each of the repetitive signal sections of the repetitive signal section group by using the preceding and following section description feature values; and

a preceding and following section difference intra-group similarity calculation unit calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

### Mode 11:

The content division position determination device according to any one of modes 6 to 10, comprising

first to third preceding and following section description feature value analysis units, at least two of which are disposed in parallel; and

a division position reliability integration unit calculating and outputting a new division position reliability by using a plurality of division position reliabilities calculated by the preceding and following section description feature value analysis units,

wherein the first preceding and following section description feature value analysis unit comprises: a preceding and following section difference calculation unit calculating a preceding and following section difference that indicates a difference between the preceding section and the following section of each of the repetitive signal sections of the repetitive signal section group by using the preceding and following section description feature values; and a preceding and following section difference integration unit calculating the division position reliability by using preceding and following section differences corresponding to a plurality of repetitive signal sections contained in the repetitive signal section group,

wherein the second preceding and following section description feature value analysis unit comprises a preceding and following section description feature value intra-group similarity calculation unit calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity, and

wherein the third preceding and following section description feature value analysis unit comprises: the preceding and following section difference calculation unit; and a preceding and following section difference intra-group similarity calculation unit calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

### Mode 12:

The content division position determination device according to mode 11, wherein the division position reliability integration unit integrates the plurality of division position reliabilities based on at least one process selected from an average value calculation process, a weighted addition process, a maximum value calculation process, a median value calculation process, and a most frequent value calculation process to calculate and output a new division position reliability.

### Mode 13:

The content division position determination device according to mode 11, wherein the division position reliability integration unit compares a value of each of the plurality of division position reliabilities with a predetermined threshold value, determines the number of division position reliabilities of which value is larger than the predetermined threshold value, and calculates and outputs a new division position reliability based on the number.

### Mode 14:

The content division position determination device according to any one of modes 1 to 13, further comprising a division position information output unit determining whether the repetitive signal section group indicates division positions based on the division position reliability and outputting, when the division positions are determined, information for identifying the division positions as division position information based on the repetitive signal section group information.

### Mode 15:

The content division position determination device according to any one of modes 1 to 14, further comprising:

a content database storing a plurality of contents; and

a series content acquisition unit acquiring, when supplied with series information for identifying a series of a content, at least one content corresponding to a series identified by the series information from the content database and supplying the acquired content to the signal section group detection unit.

### Mode 16:

Refer to the content viewing control device of the second aspect.

### Mode 17:

The content viewing control device according to mode 16, comprising:

a division position database storing the division position information or the repetitive signal section group and the division position reliability thereof for a plurality of contents; and

a content viewing control unit acquiring, when a content is supplied, the division position information or the repetitive signal section group and the division position reliability thereof for the content from the division position database and controlling viewing of the content based on the acquired division position information or the repetitive signal section group and the division position reliability thereof.

Mode 18: Refer to the content division position determination method of the third aspect. The content division position determination method is feasible on the content division position determination device of the first aspect and is tied to the device.

### Mode 19:

The content division position determination method according to mode 18, wherein the preceding and following section description feature value analysis step comprises:

a preceding and following section difference calculation step of calculating a preceding and following section difference that indicates a difference between the preceding section and the following section of each of the repetitive signal sections of the repetitive signal section group by using the preceding and following section description feature values; and

a preceding and following section difference integration step of calculating the division position reliability by using preceding and following section differences corresponding to a plurality of repetitive signal sections contained in the repetitive signal section group.

### Mode 20:

The content division position determination method according to mode 18, wherein the preceding and following section description feature value analysis step comprises a preceding and following section description feature value intra-group similarity calculation step of calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity.

### Mode 21:

The content division position determination method according to mode 18, wherein the preceding and following section description feature value analysis step comprises:

a preceding and following section difference calculation step of calculating a preceding and following section difference that indicates a difference between the preceding section and the following section of each of the repetitive signal sections of the repetitive signal section group by using the preceding and following section description feature values; and

a preceding and following section difference intra-group similarity calculation step of calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

### Mode 22:

The content division position determination method according to any one of modes 18 to 21, comprising

first to third preceding and following section description feature value analysis steps, at least two of which are executed in parallel; and

a division position reliability integration step of calculating and outputting a new division position reliability by using a plurality of division position reliabilities calculated by the preceding and following section description feature value analysis steps,

wherein the first preceding and following section description feature value analysis step comprises: a preceding and following section difference calculation step of calculating a preceding and following section difference that indicates a difference between the preceding section and the following section of each of the repetitive signal sections of the repetitive signal section group by using the preceding and following section description feature values; and a preceding and following section difference integration step of calculating the division position reliability by using preceding and following section differences corresponding to a plurality of repetitive signal sections contained in the repetitive signal section group,

wherein the second preceding and following section description feature value analysis step comprises a preceding and following section description feature value intra-group similarity calculation step of calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity, and

wherein the third preceding and following section description feature value analysis step comprises: the preceding and following section difference calculation step; and a preceding and following section difference intra-group similarity calculation step of calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

### Mode 23:

The content division position determination method according to any one of modes 18 to 22, further comprising a division position information output step of determining whether the repetitive signal section group indicates division positions based on the division position reliability and outputting, when the division positions are determined, information for identifying the division positions as division position information based on the repetitive signal section group information.

### Mode 24:

The content division position determination method according to any one of modes 18 to 23, further comprising a series content acquisition step of acquiring, when supplied with series information for identifying a series of a content, at least one content corresponding to a series identified by the series information from a content database storing a plurality of contents and supplying the acquired content to the signal section group detection unit.

### Mode 25:

A content viewing control method for controlling viewing of a content, comprising:

a repetitive signal section group detection step of detecting, when supplied with at least one content, a group of repetitive signal sections in which signals are similar to one another as a repetitive signal section group from the content and outputting information for identifying each of the repetitive signal sections contained in the repetitive signal section group as repetitive signal section group information;

a preceding and following section description feature value extraction step of extracting, from the content, preceding and following section description feature values, which are feature values describing the preceding and following sections of each of the repetitive signal sections identified by the repetitive signal section group information;

a preceding and following section description feature value analysis step of calculating a division position reliability that indicates a probability that the repetitive signal section group indicates division positions by using the preceding and following section description feature values corresponding to a plurality of repetitive signal sections contained in the repetitive signal section group; and

a viewing control step of controlling viewing of the content based on the division position information or the repetitive signal section group and the division position reliability thereof.

### Mode 26:

The content viewing control method according to mode 25, further comprising:

a storage step of storing the division position information or the repetitive signal section group and the division position reliability thereof for a plurality of contents in a division position database; and

a step of acquiring, when a content is supplied, the division position information or the repetitive signal section group and the division position reliability thereof for the content from the division position database,

wherein, in the viewing control step, viewing of the content is controlled based on the acquired division position information or the acquired repetitive signal section group and the division position reliability thereof.

### Mode 27:

Refer to the program of the fourth aspect. This program is recordable or storable onto a recording medium which is readable by a computer.

### Mode 28:

The program according to mode 27, wherein the preceding and following section description feature value analysis process comprises:

a preceding and following section difference calculation process to calculate a preceding and following section difference that indicates a difference between the preceding section and the following section of each of the repetitive signal sections of the repetitive signal section group by using the preceding and following section description feature values; and

a preceding and following section difference integration process to calculate the division position reliability by using preceding and following section differences corresponding to a plurality of repetitive signal sections contained in the repetitive signal section group.

### Mode 29:

The program according to mode 27, wherein the preceding and following section description feature value analysis process comprises a preceding and following section description feature value intra-group similarity calculation process to calculate a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity.

### Mode 30:

The program according to mode 27, wherein the preceding and following section description feature value analysis process comprises:

a preceding and following section difference calculation process to calculate a preceding and following section difference that indicates a difference between the preceding section and the following section of each of the repetitive signal sections of the repetitive signal section group by using the preceding and following section description feature values; and

a preceding and following section difference intra-group similarity calculation process to calculate a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

### Mode 31:

The program according to any one of modes 27 to 30, causing the computer to execute at least two of first to third preceding and following section description feature value analysis processes in parallel; and a division position reliability integration process to calculate and outputting a new division position reliability by using a plurality of division position reliabilities calculated by the preceding and following section description feature value analysis processes,

wherein the first preceding and following section description feature value analysis process comprises: a preceding and following section difference calculation process to calculate a preceding and following section difference that indicates a difference between the preceding section and the following section of each of the repetitive signal sections of the repetitive signal section group by using the preceding and following section description feature values; and a preceding and following section difference integration process to calculate the division position reliability by using preceding and following section differences corresponding to a plurality of repetitive signal sections contained in the repetitive signal section group,

wherein the second preceding and following section description feature value analysis process comprises a preceding and following section description feature value intra-group similarity calculation process to calculate a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity, and

wherein the third preceding and following section description feature value analysis process comprises: the preceding and following section difference calculation process; and a preceding and following section difference intra-group similarity calculation process to calculate a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

### Mode 32:

The program according to any one of modes 27 to 31, causing the computer to execute a division position information output process to determine whether the repetitive signal section group indicates division positions based on the division position reliability and outputting, when the division positions are determined, information for identifying the division positions as division position information based on the repetitive signal section group information.

### Mode 33:

The program according to any one of modes 27 to 32, causing the computer to execute a series content acquisition process to acquire, when supplied with series information for identifying a series of a content, at least one content corresponding to a series identified by the series information from the content database storing a plurality of contents and supplying the acquired content to the signal section group detection unit.

### Mode 34:

A program causing a computer to execute a content viewing control process, the program causing the computer to execute:

a repetitive signal section group detection process to detect, when supplied with at least one content, a group of repetitive signal sections in which signals are similar to one another as a repetitive signal section group from the content and outputting information for identifying each of the repetitive signal sections contained in the repetitive signal section group as repetitive signal section group information;

a preceding and following section description feature value extraction process extract, from the content, preceding and following section description feature values, which are feature values describing the preceding and following sections of each of the repetitive signal sections identified by the repetitive signal section group information;

a preceding and following section description feature value analysis process to calculate a division position reliability that indicates a probability that the repetitive signal section group indicates division positions by using the preceding and following section description feature values corresponding to a plurality of repetitive signal sections contained in the repetitive signal section group; and

a viewing control process to control viewing of the content based on the division position information or the repetitive signal section group and the division position reliability thereof.

### Mode 35:

The program according to mode 34, causing the computer to execute: a storage process to store the division position information or the repetitive signal section group and the division position reliability thereof for a plurality of contents in a division position database; and

a process to acquire, when a content is supplied, the division position information or the repetitive signal section group and the division position reliability thereof for the content from the division position database,

wherein, in the viewing control process, viewing of the content is controlled based on the acquired division position information or the acquired repetitive signal section group and the division position reliability thereof.

What is claimed is:

1. A content division position determination device for determining temporal division positions of a content, the device comprising:
a repetitive signal section group detection unit detecting, when supplied with at least one content, a group of repetitive signal sections in which signals are similar to one another as a repetitive signal section group from the content and outputting information for identifying each of the repetitive signal sections contained in the repetitive signal section group as repetitive signal section group information;
a preceding and following section description feature value extraction unit extracting, from the content, preceding and following section description feature values, which are feature values describing the preceding and following sections of each of the repetitive signal sections identified by the repetitive signal section group information; and
a preceding and following section description feature value analysis unit calculating a division position reliability that indicates a probability that each of the repetitive signal sections contained in the repetitive signal section group indicates a division position by using the preceding and following section description feature values corresponding to a plurality of repetitive signal sections contained in the repetitive signal section group.

2. The content division position determination device according to claim 1, wherein the preceding and following section description feature value extraction unit extracts an object from a preceding or following section of the content and extracts a feature value describing the extracted object as a preceding and following section description feature value.

3. The content division position determination device according to claim 2, wherein the object comprises at least one selected from a face, a figure, a thing, text, a screen structure, a speech sentence, and music.

4. The content division position determination device according to claim 1, wherein the preceding and following section description feature value extraction unit extracts a feature value describing a scene situation of a preceding or following section of the content as a preceding and following section description feature value.

5. The content division position determination device according to claim 1, wherein the preceding and following section description feature value analysis unit calculates the division position reliability based on a comparison between the preceding and following section description feature values and preceding and following section description feature values of a repetitive signal section group that indicates previously learned meaningful division positions.

6. The content division position determination device according to claim 1, wherein the preceding and following section description feature value analysis unit comprises:
a preceding and following section difference calculation unit calculating a preceding and following section difference that indicates a difference between the preceding section and the following section of each of the repetitive signal sections of the repetitive signal section group by using the preceding and following section description feature values; and
a preceding and following section difference integration unit calculating the division position reliability by using preceding and following section differences corresponding to a plurality of repetitive signal sections contained in the repetitive signal section group.

7. The content division position determination device according to claim 6,
wherein the preceding and following section difference integration unit calculates a preceding and following section difference by integrating the plurality of preceding and following section differences based on at least one process selected from an average value calculation process, a weighted addition process, a maximum value calculation process, a median value calculation process, and a most frequent value calculation process, and
wherein the preceding and following section difference integration unit calculates a larger value as the division position reliability when a larger value is calculated as the integrated preceding and following section difference.

8. The content division position determination device according to claim 6, wherein the preceding and following section difference integration unit compares a value of each of the plurality of preceding and following section differences with a predetermined threshold value, determines the number of preceding and following section differences of which value is larger than the predetermined threshold value, and calculates a larger value as the division position reliability when the number is larger.

9. The content division position determination device according to claim 1, wherein the preceding and following section description feature value analysis unit comprises a preceding and following section description feature value intra-group similarity calculation unit calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity.

10. The content division position determination device according to claim 1, wherein the preceding and following section description feature value analysis unit comprises:
a preceding and following section difference calculation unit calculating a preceding and following section difference that indicates a difference between the preceding section and the following section of each of the repetitive signal sections of the repetitive signal section group by using the preceding and following section description feature values; and
a preceding and following section difference intra-group similarity calculation unit calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

11. The content division position determination device according to claim 6, comprising
first to third preceding and following section description feature value analysis units, at least two of which are disposed in parallel; and
a division position reliability integration unit calculating and outputting a new division position reliability by using a plurality of division position reliabilities calculated by the preceding and following section description feature value analysis units,
wherein the first preceding and following section description feature value analysis unit comprises: a preceding and following section difference calculation unit calculating a preceding and following section difference that indicates a difference between the preceding section and the following section of each of the repetitive signal sections of the repetitive signal section group by using the preceding and following section description feature values; and a preceding and following section difference integration unit calculating the division position reliability by using preceding and following section differences corresponding to a plurality of repetitive signal sections contained in the repetitive signal section group,
wherein the second preceding and following section description feature value analysis unit comprises a preceding and following section description feature value intra-group similarity calculation unit calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity, and
wherein the third preceding and following section description feature value analysis unit comprises: the preceding and following section difference calculation unit; and a preceding and following section difference intra-group similarity calculation unit calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

12. The content division position determination device according to claim 11, wherein the division position reliability integration unit integrates the plurality of division position reliabilities based on at least one process selected from an average value calculation process, a weighted addition process, a maximum value calculation process, a median value calculation process, and a most frequent value calculation process to calculate and output a new division position reliability.

13. The content division position determination device according to claim 11, wherein the division position reliability integration unit compares a value of each of the plurality of division position reliabilities with a predetermined threshold value, determines the number of division position reliabilities of which value is larger than the predetermined threshold value, and calculates and outputs a new division position reliability based on the number.

14. The content division position determination device according to claim 1, further comprising a division position information output unit for determining whether the repetitive signal section group indicates division positions based on the division position reliability and outputting, when the division positions are determined, information for identifying the division positions as division position information based on the repetitive signal section group information.

15. The content division position determination device according to claim 1, further comprising:
a content database storing a plurality of contents; and
a series content acquisition unit acquiring, when supplied with series information for identifying a series of a content, at least one content corresponding to a series identified by the series information from the content database and supplying the acquired content to the signal section group detection unit.

16. A content viewing control device for controlling viewing of the content, based on the division position information or the repetitive signal section group and the division position reliability thereof outputted by the content division position determination device according to claim 1.

17. The content viewing control device according to claim 16, comprising:
a division position database storing the division position information or the repetitive signal section group and the division position reliability thereof for a plurality of contents; and
a content viewing control unit acquiring, when a content is supplied, the division position information or the repetitive signal section group and the division position reliability thereof for the content from the division position database and controlling viewing of the content based on the acquired division position information or the repetitive signal section group and the division position reliability thereof.

18. A content division position determination method for determining temporal division positions of a content, the method comprising:
detecting, when supplied with at least one content, a group of repetitive signal sections in which signals are similar to one another as a repetitive signal section group from the content and outputting information for identifying each of the repetitive signal sections contained in the repetitive signal section group as repetitive signal section group information (termed as “repetitive signal section group detection step”);
extracting, from the content, preceding and following section description feature values, which are feature values describing the preceding and following sections of each of the repetitive signal sections identified by the repetitive signal section group information by a computer (termed as “preceding and following section description feature value extraction step”); and
calculating a division position reliability that indicates a probability that each of the repetitive signal sections contained in the repetitive signal section group indicates a division position by using the preceding and following section description feature values corresponding to a plurality of repetitive signal sections contained in the repetitive signal section group by said computer (termed as “preceding and following section description feature value analysis step”).

19-21. (canceled)

22. The content division position determination method according to claim 18, comprising
first to third preceding and following section description feature value analysis steps, at least two of which are executed in parallel by said computer; and
a division position reliability integration step of calculating and outputting a new division position reliability by using a plurality of division position reliabilities calculated by the preceding and following section description feature value analysis steps by said computer,
wherein the first preceding and following section description feature value analysis step comprises: a preceding and following section difference calculation step of calculating a preceding and following section difference that indicates a difference between the preceding section and the following section of each of the repetitive signal sections of the repetitive signal section group by using the preceding and following section description feature values; and a preceding and following section difference integration step of calculating the division position reliability by using preceding and following section differences corresponding to a plurality of repetitive signal sections contained in the repetitive signal section group,
wherein the second preceding and following section description feature value analysis step comprises a preceding and following section description feature value intra-group similarity calculation step of calculating a preceding and following section description feature value intra-group similarity, which represents a similarity among the preceding and following section description feature values extracted from the individual repetitive signal sections of the repetitive signal section group, and calculating a larger value as the division position reliability when a larger value is calculated as the preceding and following section description feature value intra-group similarity, and
wherein the third preceding and following section description feature value analysis step comprises: the preceding and following section difference calculation step; and a preceding and following section difference intra-group similarity calculation step of calculating a preceding and following section difference intra-group similarity, which represents a similarity of preceding and following section difference calculated for each of the repetitive signal sections of the repetitive signal section group, and calculating a larger value as the division position reliability when a larger value is calculated as the preceding and following section difference intra-group similarity.

23-26. (canceled)

27. A program causing a computer to execute a content division position determination process to determine temporal division positions of a content, the program causes a computer to execute:
a repetitive signal section group detection process to detect, when supplied with at least one content, a group of repetitive signal sections in which signals are similar to one another as a repetitive signal section group from the content and outputting information for identifying each of the repetitive signal sections contained in the repetitive signal section group as repetitive signal section group information;
a preceding and following section description feature value extraction process to extract, from the content, preceding and following section description feature values, which are feature values describing the preceding and following sections of each of the repetitive signal sections identified by the repetitive signal section group information; and
a preceding and following section description feature value analysis process to calculate a division position reliability that indicates a probability that each of the repetitive signal sections contained in the repetitive signal section group indicates a division position by using the preceding and following section description feature values corresponding to a plurality of repetitive signal sections contained in the repetitive signal section group.

28-35. (canceled)
